(19) United States
(12) Patent Application Publication
(10) Pub. No.: US 2026/0081642 A1
(43) Pub. Date: Mar. 19, 2026

(54) ELECTRONIC DEVICE AND METHOD FOR RELAYING COMMUNICATION WITH DESIGNATED NETWORK

(71) Applicant: Samsung Electronics Co., Ltd., Suwon-si (KR)

(72) Inventors: Yohan MOON, Suwon-si (KR); Hyoseok NA, Suwon-si (KR); Dongil YANG, Suwon-si (KR); Hyunsang KANG, Suwon-si (KR); Seonjun KIM, Suwon-si (KR); Jonghun YOO, Suwon-si (KR); Namjun CHO, Suwon-si (KR)

(21) Appl. No.: 19/398,362

(22) Filed: Nov. 24, 2025

Related U.S. Application Data
(63) Continuation of application No. PCT/KR2024/006994, filed on May 23, 2024.

(30) Foreign Application Priority Data
May 24, 2023 (KR) 10-2023-0066977
Jul. 6, 2023 (KR) 10-2023-0087645

(51) Int. Cl. H04B 1/50; H04L 5/14

(52) U.S. Cl. CPC H04B 1/50; H04L 5/14

(57) ABSTRACT

A system and a method for relaying communications with a designated network are provided. The first electronic device for relaying communication with the designated network includes a first communication circuit for receiving a first signal in a first frequency band from the designated network, a transceiver for receiving the first signal in the first frequency band from the first communication circuit, and a second communication circuit which includes a second duplexer for receiving, from the transceiver, a first signal in a second frequency band, which is generated from the first signal in the first frequency band, and transmits the first signal in the second frequency band to a second electronic device. The first signal in the second frequency band is provided to a third duplexer corresponding to a third frequency band included in the second electronic device. A partial frequency region in the second frequency band overlaps with the third frequency band.

### CROSS-REFERENCE TO RELATED APPLICATION(S)

This application is a continuation application, claiming priority under 35 U.S.C. § 365 (c), of an International application No. PCT/KR2024/006994, filed on May 23, 2024, which is based on and claims the benefit of a Korean patent application number 10-2023-0066977, filed on May 24, 2023, in the Korean Intellectual Property Office, and of a Korean patent application number 10-2023-0087645, filed on Jul. 6, 2023, in the Korean Intellectual Property Office, the disclosure of each of which is incorporated by reference herein in its entirety.

### BACKGROUND

### 1. Field

The disclosure relates to a system and method for relaying communication with a designated network.

### 2. Description of Related Art

A mobile electronic device has a communication module mounted thereon to support communication (e.g., satellite communication or disaster communication) which is usable in emergency situations, in addition to a typical cell band. Further, the mobile electronic device supports Time Division Duplex (TDD)-type wireless transmission and reception and Frequency Division Duplex (FDD)-type wireless transmission and reception. According to the TDD-type wireless transmission and reception, a single frame may be divided into a transmission section and a reception section, thereby enabling bidirectional communication using a single frequency. On the other hand, in the FDD-type wireless transmission and reception, bidirectional communication may be performed using two different frequencies within the same time frame (or slot) in a frequency division transmission scheme.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for relaying communication with a designated network.

Additional aspects will be set forth in part in the description which follows and, in part, will be apparent from the description, or may be learned by practice of the presented embodiments.

In accordance with an aspect of the disclosure, a first electronic device for relaying communication with a designated network is provided. The first electronic device includes a first communication circuit for receiving a first signal in a first frequency band from the designated network, a transceiver for receiving the first signal in the first frequency band from the first communication circuit, and a second communication circuit which includes a second duplexer for receiving, from the transceiver, a first signal in a second frequency band, which is generated from the first signal in the first frequency band, and transmits the first signal in the second frequency band to a second electronic device, wherein the first signal in the second frequency band is provided to a third duplexer corresponding to a third frequency band included in the second electronic device, wherein a partial frequency region in the second frequency band overlaps with the third frequency band, and wherein the first signal in the second frequency band is a signal of the partial frequency region which overlaps with the third frequency band.

In accordance with another aspect of the disclosure, a second electronic device for requesting transmission of a signal to a designated network is provided. The second electronic device includes an antenna, a transceiver, and a fourth communication circuit which includes a fourth duplexer for receiving a second signal in a fourth frequency band from the transceiver, and transmits the second signal in the fourth frequency band to a first electronic device via the antenna, the second signal in the fourth frequency band having a partial frequency region overlapping with a second frequency band of the first electronic device, wherein the second signal in the fourth frequency band is received by a second communication circuit corresponding to the second frequency band within the first electronic device, and wherein the second signal in the fourth frequency band is converted into a second signal in a first frequency band of the designated network by the first electronic device and is transmitted from the first electronic device to the designated network.

In accordance with another aspect of the disclosure, a system for relaying communication with a designated network is provided. The system includes a first electronic device including a first communication circuit including a first duplexer which receives a first signal in a first frequency band from the designated network, a transceiver for receiving the first signal in the first frequency band from the first communication circuit, and a second communication circuit which includes a second duplexer for receiving, from the transceiver, a first signal in a second frequency band, which is generated from the first signal in the first frequency band, and transmits the first signal in the second frequency band to a second electronic device, and a second electronic device including a fourth communication circuit including a third duplexer of a third frequency band for receiving the first signal in the second frequency band, the second frequency band having a partial frequency region overlapping with the third frequency band, and a transceiver wherein the fourth communication circuit includes a fourth duplexer for receiving from the transceiver a second signal in a fourth frequency band of which a partial frequency region overlaps with the second frequency band, and wherein the fourth communication circuit transmits the second signal in the fourth frequency band to the first electronic device.

In accordance with another aspect of the disclosure, a method in which a first electronic device relays communication with a designated network is provided. The method includes receiving a first signal in a first frequency band, provided from the designated network, via a first communication circuit for processing signals of the first frequency band, generating a first signal in a second frequency band from the first signal in the first frequency band, providing the first signal in the second frequency band to a second communication circuit for processing signals in the second frequency band, and transmitting the first signal in the second frequency band to a second electronic device via the second communication circuit. The first signal in the second frequency band is provided to a third duplexer corresponding to a third frequency band included in the second electronic device. A partial frequency region in the second frequency band overlaps with the third frequency band. The first signal in the second frequency band is a signal of the partial frequency region which overlaps with the third frequency band.

In accordance with another aspect of the disclosure, a method in which a second electronic device requests transmission of a signal to a designated network is provided. The method includes generating a second signal in a fourth frequency band of which a partial frequency region overlaps with a second frequency band of a first electronic device, and transmitting the second signal in the fourth frequency band to a first electronic device via a fourth communication circuit which includes a fourth duplexer for receiving the second signal in the fourth frequency band from the transceiver. The second signal in the fourth frequency band is received by a second communication circuit corresponding to the second frequency band within the first electronic device. The second signal in the fourth frequency band is converted into a second signal in a first frequency band of the designated network by the first electronic device and transmitted from the first electronic device to the designated network.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 schematically illustrates a system for relaying communication with a designated network, according to an embodiment of the disclosure;

FIG. 2 is a block diagram of a first electronic device and a second electronic device, according to an embodiment of the disclosure;

FIG. 3A illustrates an example in which a first electronic device provides a signal from a designated network to a second electronic device, according to an embodiment of the disclosure;

FIG. 3B illustrates an example in which a second electronic device receives a signal from a designated network relayed by a first electronic device, according to an embodiment of the disclosure;

FIG. 4A illustrates an example in which a second electronic device transmits a signal to be provided to a designated network by a first electronic device, according to an embodiment of the disclosure;

FIG. 4B illustrates an example in which a first electronic device provides a signal from a second electronic device to a designated network, according to an embodiment of the disclosure;

FIG. 5 illustrates an example in which a second frequency band and a third frequency band overlap, according to an embodiment of the disclosure;

FIG. 6 illustrates an example in which a fourth frequency band and a second frequency band overlap, according to an embodiment of the disclosure;

FIG. 7 illustrates an example in which a switching module is provided in a second communication circuit of a first electronic device, according to an embodiment of the disclosure;

FIG. 8 illustrates an example in which a switching module is included in a fourth communication circuit of a second electronic device, according to an embodiment of the disclosure;

FIG. 9A illustrates an example in which a first signal in a second frequency band, converted from a first signal in a first frequency band, is provided from a first communication circuit to a second communication circuit within a first electronic device through switching, according to an embodiment of the disclosure;

FIG. 9B illustrates an example in which a first signal in a first frequency band, converted from a second signal in a fourth frequency band, is provided from a second communication circuit to a first communication circuit within a first electronic device through switching, according to an embodiment of the disclosure;

FIG. 10A illustrates an example in which a first signal in a second frequency band is provided from a fourth communication circuit to a communication processor within a first electronic device, according to an embodiment of the disclosure;

FIG. 10B illustrates an example in which a second signal in a fourth frequency band is provided from a communication processor to a fourth communication circuit through switching, according to an embodiment of the disclosure;

FIG. 11 is a flowchart illustrating a method in which a first electronic device relays a signal from a designated network to a second electronic device, according to an embodiment of the disclosure;

FIG. 12 is a flowchart illustrating a method in which a first electronic device relays a signal from a second electronic device to a designated network, according to an embodiment of the disclosure;

FIG. 13 is a block diagram illustrating an electronic device 1301 in a network environment 1300 according to an embodiment of the disclosure; and

FIG. 14 is a block diagram 1400 illustrating an example electronic device 1301 in a network environment including a plurality of cellular networks according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, the terms ‘1st’, ‘2nd’, or the like may be used to describe various components, but the components shall not be limited by these terms. The terms are used to distinguish one component from another.

Throughout the specification, when a part is mentioned to be “connected” to another part, this includes not only a case where it is “directly connected” but also a case where it is “electrically connected” thereto with other elements interposed therebetween. Also, when a part is mentioned to “include” a component, this does not mean that it excludes other components, but rather that it may further include other components, unless otherwise specified.

Phrases such as “in an embodiment” mentioned in various sections of the disclosure do not necessarily all refer to the same embodiment.

An embodiment of the disclosure may be represented by functional block configurations and various processing operations. Some or all of these functional blocks may be implemented as various hardware and/or software components which perform specific functions. For example, the functional blocks of the disclosure may be implemented by one or more microprocessors, or may be implemented by circuit configurations designed for specific functions. Further, for example, the functional blocks of the disclosure may be implemented as various programming or scripting languages. The functional blocks may also be implemented as algorithms executed on one or more processors. Furthermore, the disclosure may employ the prior art for electronic environment configurations, signal processing, and/or data processing. Terms such as “mechanism,” “element,” “means,” and “configuration” are used broadly herein, and are not limited to mechanical or physical configurations.

In addition, connecting lines or connecting members between components shown in the drawings are provided merely as examples of functional connections and/or physical or circuit connections. In actual devices, the connections between the components may be implemented by various alternative or additional functional, physical, or circuit connections.

Hereinafter, the disclosure will be described in detail with reference to the accompanying drawings.

In the disclosure, a first signal may be a signal transmitted from a designated network and relayed to a second electronic device by a first electronic device. A second signal may be a signal transmitted from the second electronic device and relayed to the designated network by the first electronic device. The first signal and the second signal may be modulated into signals in frequency bands designated for signal relay by the first electronic device and the second electronic device.

In the disclosure, a first frequency band may be a frequency band for transmitting and receiving signals with the designated network. A second frequency band which is a frequency band of the first electronic device may be a frequency band which at least partially overlaps with a third frequency band and/or fourth frequency band of the second electronic device.

In the disclosure, a transmission frequency band may be a frequency band of a signal transmission path, and a reception frequency band may be a frequency band of a signal reception path.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

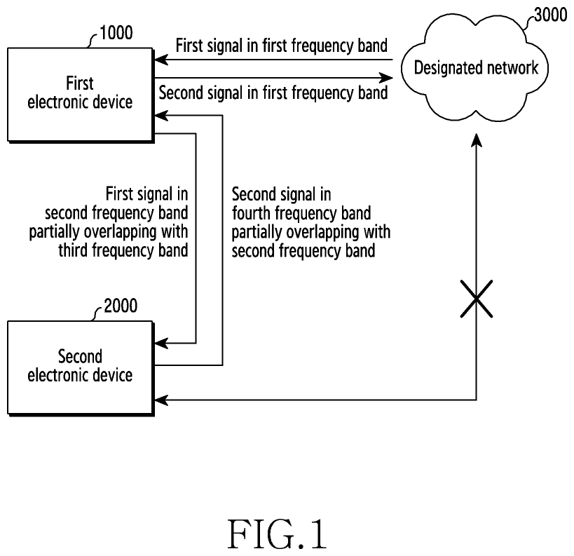

FIG. 1 schematically illustrates a system for relaying communication with a designated network, according to an embodiment of the disclosure.

Referring to FIG. 1, in an embodiment, a system for relaying communication with a designated network 3000 may include a first electronic device 1000, a second electronic device 2000, and/or the designated network 3000. The first electronic device 1000 may transmit and receive signals with the designated network via a first frequency band, whereas the second electronic device 2000 may be unable to transmit and receive signals with the designated network 3000. For example, the second electronic device 2000 may not include a communication module for transmitting and receiving signals with the designated network 3000, or the second electronic device 2000 may be located outside a coverage of the designated network 3000, such that the second electronic device 2000 may be unable to transmit and receive signals with the designated network 3000.

According to an embodiment, the first electronic device 1000 may relay communication between the second electronic device 2000 and the designated network 3000 via Device to Device (D2D) communication with the second electronic device 2000.

According to an embodiment, the first electronic device 1000 may receive a first signal in a first frequency band from the designated network 3000, generate a first signal in a second frequency band, which at least partially overlaps with a third frequency band of the second electronic device 2000, and transmit the first signal in the second frequency band to the second electronic device 2000.

According to an embodiment, the second electronic device 2000 may transmit a second signal in a fourth frequency band, which at least partially overlaps with the second frequency band of the first electronic device 1000, to the first electronic device 1000, and the first electronic device 1000 may convert the second signal in the fourth frequency band into a second signal in the first frequency band and transmit the second signal in the first frequency band to the designated network 3000.

According to an embodiment, the first electronic device 1000 and the second electronic device 2000 may transmit and receive the first signal and the second signal via Frequency Division Duplexing (FDD)-type communication. For example, communication between the first electronic device 1000, the second electronic device 2000, and the designated network 3000 may be the FDD-type communication.

According to an embodiment, the designated network 3000 may be a network for satellite communication or a network for transmitting and receiving signals in a disaster situation. For example, the first frequency band of the designated network 3000 may be an n256 band or an n255 band. Alternatively, for example, the first frequency band of the designated network may be a frequency band designated for transmitting and receiving signals in the disaster situation.

According to an embodiment, the second frequency band, the third frequency band, and the fourth frequency band may be frequency bands for 3rd Generation (3G), 4th Generation (4G), 5th Generation (5G), or 6th Generation (6G) communication. For example, the second frequency band may be Band 25, the third frequency band may be Band 3, and the fourth frequency band may be Band 1.

According to an embodiment, the first electronic device 1000 may be a smartphone, a tablet Personal Computer (PC), a PC, a smart television (TV), a mobile phone, a Personal Digital Assistant (PDA), a laptop, a media player, a Global Positioning System (GPS) device, an e-book reader, a digital broadcast terminal, a navigation device, a kiosk, an MP3 player, a digital camera, a home appliance, or other mobile or non-mobile computing device, but is not limited thereto. In addition, the first electronic device 1000 may be a wearable device such as a watch, glasses, headband, and/or ring equipped with data processing capabilities. However, the first electronic device 1000 is not limited thereto, and may include any type of device capable of transmitting and receiving signals with other electronic devices via a network.

According to an embodiment, the second electronic device 2000 may be a smartphone, a tablet PC, a PC, a smart TV, a mobile phone, a PDA, a laptop, a media player, a GPS device, an e-book reader, a digital broadcast terminal, a navigation device, a kiosk, an MP3 player, a digital camera, a home appliance, or other mobile or non-mobile computing device, but is not limited thereto. In addition, the second electronic device 2000 may be a wearable device such as a watch, glasses, headband, and/or ring equipped with data processing capabilities. However, the second electronic device 2000 is not limited thereto, and may include any type of device capable of transmitting and receiving signals with other electronic devices via a network.

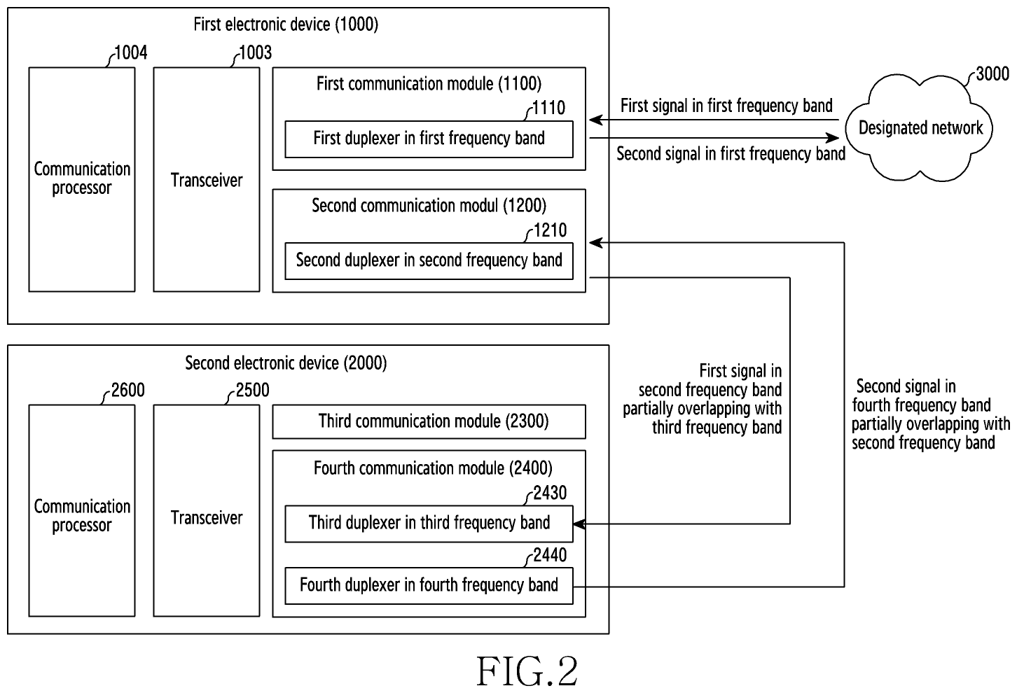

FIG. 2 is a block diagram of a first electronic device and a second electronic device, according to an embodiment of the disclosure.

Referring to FIG. 2, according to an embodiment, a first electronic device 1000 may include a first communication circuit 1100, a second communication circuit 1200, a transceiver 1003, and a communication processor 1004. For example, the first communication circuit 1100 may include a first duplexer 1110 in a first frequency band, and the second communication circuit 1200 may include a second duplexer 1210 in a second frequency band. According to an embodiment, the first communication circuit 1100 may include an RF Front-End Module (FEM) and/or an RF Front-End (RFFE) circuit. According to an embodiment, the second communication circuit 1200 may include an FEM and/or an RFFE circuit.

According to an embodiment, the first communication circuit 1100 may transmit and receive signals in the first frequency band with a designated network 3000. The first communication circuit 1100 may receive a first signal in the first frequency band from the designated network 3000 via the first duplexer 1110 and provide the received first signal in the first frequency band to the transceiver 1003. The first communication circuit 1100 may receive a second signal in the first frequency band from the transceiver 1003 and transmit the second signal in the first frequency band to the designated network 3000 via the first duplexer 1110.

According to an embodiment, the designated network 3000 may include a network for satellite communication or a network for transmitting and receiving signals in a disaster situation. The first frequency band may include, for example, an n256 band or an n255 band, but is not limited thereto. For example, when the first frequency band is the n256 band, a transmission frequency band in the first frequency band may be 1980 MHz to 2010 MHz, and a reception frequency band in the first frequency band may be 2170 MHz to 2200 MHz. The transmission frequency band may be a frequency band of a signal transmission path, and the reception frequency band may be a frequency band of a signal reception path.

According to an embodiment, the first electronic device 1000 may receive the first signal in the first frequency band from the first communication circuit 1100, and may modulate the first signal in the first frequency band into a first signal in the second frequency band. For example, the transceiver 1003 and/or communication processor 1004 of the first electronic device 1000 may receive the first signal in the first frequency band from the communication circuit 1100 and modulate the received first signal into the first signal in the second frequency band.

According to an embodiment, the second frequency band may at least partially overlap with a third frequency band of a second electronic device 2000. For example, the second frequency band of the first signal to be transmitted from the first electronic device 1000 and the third frequency band of the second electronic device 2000 which receives the first signal may be preset. If the second frequency band and the third frequency band are not preset, the first electronic device 1000 may receive information on frequency bands of signals which are processable by the second electronic device 2000 from the second electronic device 2000, and based on the received information, may determine the second frequency band and the third frequency band. For example, the second frequency band may be Band 25, and the third frequency band may be Band 3.

According to an embodiment, the first electronic device 1000 may receive a second signal in a fourth frequency band, transmitted from the second electronic device 2000 described below to the first electronic device 1000, via the second communication circuit 1200, and may modulate the second signal in the fourth frequency band into the second signal in the first frequency band. For example, the transceiver 1003 and/or communication processor 1004 of the first electronic device 1000 may receive, via the second communication circuit 1200, the second signal in the fourth frequency band, transmitted from the second electronic device 2000 described below to the first electronic device 1000, and may modulate the received second signal in the fourth frequency band into the second signal in the first frequency band.

According to an embodiment, the fourth frequency band of the second electronic device 2000 may at least partially overlap with the second frequency band of the first electronic device 1000. For example, the fourth frequency band of the second signal to be transmitted from the second electronic device 2000 and the second frequency band of the first electronic device 1000 which receives the transmitted second signal may be preset. If the second frequency band and the fourth frequency band are not preset, the first electronic device 1000 may receive information on frequency bands of signals which are processable by the second electronic device 2000 from the second electronic device 2000, and based on the received information, may determine the second frequency band and the fourth frequency band. For example, the second frequency band may be Band 25, and the fourth frequency band may be Band 1.

According to an embodiment, the second communication circuit 1200 may transmit the first signal in the second frequency band, which at least partially overlaps with the third frequency band, to the second electronic device 2000 via the second duplexer 1210.

According to an embodiment, the second communication circuit 1200 may receive the second signal in the fourth frequency band, which at least partially overlaps with the second frequency band, from the second electronic device 2000 via the second duplexer 1210.

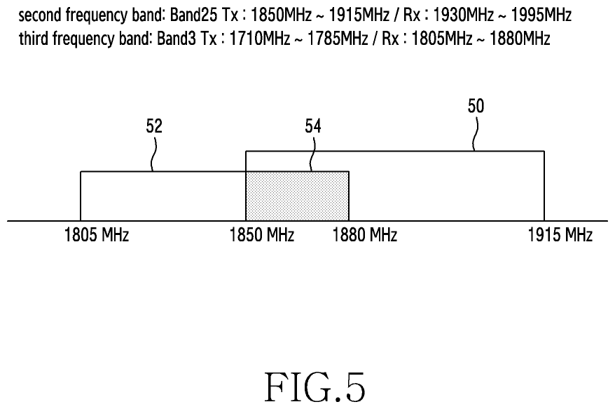

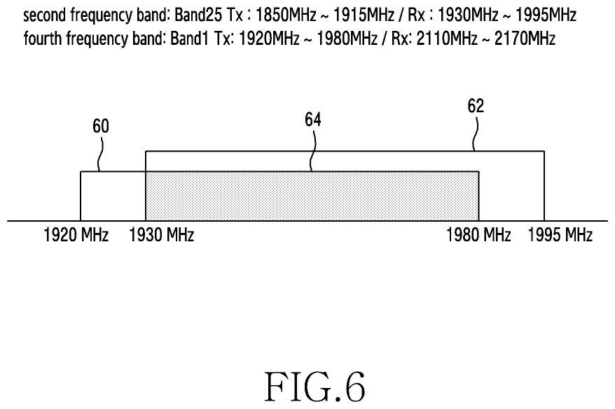

According to an embodiment, for example, the second frequency band, the third frequency band, and the fourth frequency band may be frequency bands for 3G, 4G, 5G, or 6G communication. For example, the second frequency band may be Band 25, the third frequency band may be Band 3, and the fourth frequency band may be Band 1. An example in which the second frequency band and the third frequency band overlap and an example in which the fourth frequency band and the second frequency band overlap will be described later with reference to FIGS. 5 and 6.

According to an embodiment, the communication processor 1004 may control the first communication circuit 1100, the second communication circuit 1200, and the transceiver 1003. The communication processor 1004 may establish a communication channel for transmitting and receiving signals in the first frequency band via the first communication circuit 1100, and support network communication through the established communication channel. The communication processor 1004 may establish a communication channel for transmitting and receiving signals in the second frequency band via the second communication circuit 1200, and support network communication through the established communication channel.

According to an embodiment, the second electronic device 2000 may include a third communication circuit 2300, a fourth communication circuit 2400, a transceiver 2500, and/or a communication processor 2600. For example, the fourth communication circuit 2400 may include a third duplexer 2430 in the third frequency band and a fourth duplexer 2440 in the fourth frequency band. According to an embodiment, the third communication circuit 2300 may include an FEM and/or an RFFE circuit. According to an embodiment, the fourth communication circuit 2400 may include an FEM and/or an RFFE circuit.

According to an embodiment, the fourth communication circuit 2400 may receive the first signal in the second frequency band, which partially overlaps with the third frequency band, from the first electronic device 1000 via the third duplexer 2430 in the third frequency band, and may provide the received first signal in the second frequency band to the transceiver 2500.

According to an embodiment, the fourth communication circuit 2400 may receive the second signal in the fourth frequency band, which partially overlaps with the second frequency band, from the transceiver 2500, and may transmit the second signal in the fourth frequency band to the first electronic device 1000 via the fourth duplexer 2440.

According to an embodiment, the second frequency band, the third frequency band, and the fourth frequency band may be frequency bands for 3G, 4G, 5G, or 6G communication. For example, the second frequency band may be Band 25, the third frequency band may be Band 3, and the fourth frequency band may be Band 1. An example in which the second frequency band and the third frequency band overlap and an example in which the fourth frequency band and the second frequency band overlap will be described later with reference to FIGS. 5 and 6.

According to an embodiment, the transceiver 2500 of the second electronic device 2000 may receive the first signal in the second frequency band from the fourth communication circuit 2400, process the first signal in the second frequency band, and provide the processed signal to the communication processor 2600.

According to an embodiment, the transceiver 2500 of the second electronic device 2000 may generate the second signal to be provided to the designated network 3000 as a signal in the fourth frequency band which partially overlaps with the second frequency band of the first electronic device 1000. The transceiver 2500 may provide the second signal in the fourth frequency band to the fourth duplexer 2440. For example, the fourth frequency band of the second signal to be transmitted to the first electronic device 1000 may be preset. If the fourth frequency band is not preset, the second electronic device 2000 may receive, from the first electronic device 1000, information on frequency bands of signals which are processable by the first electronic device 1000, and based on the received information, may determine the fourth frequency band as a frequency band for the second signal.

According to an embodiment, the communication processor 2600 may control the third communication circuit 2300, the fourth communication circuit 2400, and the transceiver 2500. The communication processor 2600 may establish a communication channel for transmitting and receiving signals via the third communication circuit 2300, and support network communication through the established communication channel. The communication processor 2600 may establish a communication channel for receiving signals in the second frequency band and transmitting signals in the fourth frequency band via the fourth communication circuit 2400, and support network communication through the established communication channel.

According to an embodiment, the third communication circuit 2300 may be omitted from the second electronic device 2000, but the disclosure is not limited thereto.

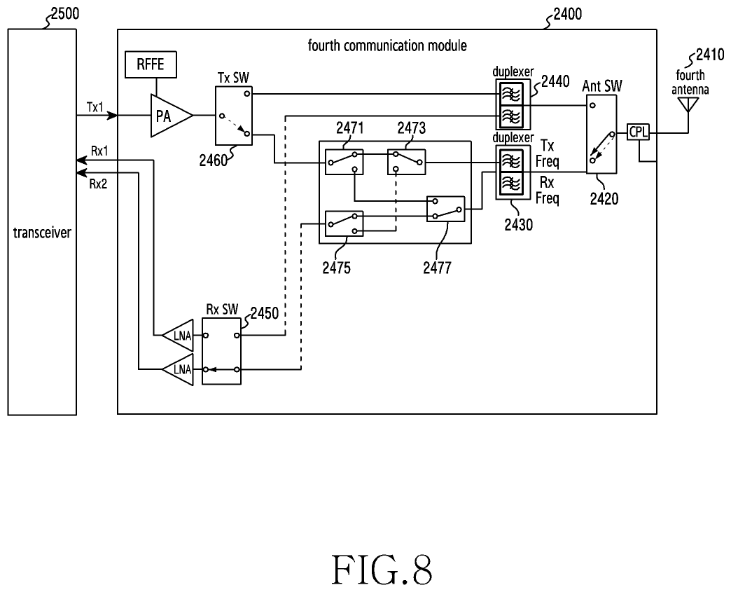

While it has been described above that the second frequency band of the first electronic device 1000 and the third frequency band of the second electronic device 2000 partially overlap, and that the fourth frequency band of the second electronic device 2000 partially overlaps with the second frequency band of the first electronic device 1000, the frequency bands used by the first electronic device 1000 and the second electronic device 2000 for transmitting and receiving signals are not limited thereto. For example, when the frequency band of the communication circuit of the first electronic device 1000 is the same as the frequency band of the communication circuit of the second electronic device 2000, the first electronic device 1000 and the second electronic device 2000 may transmit and receive signals to and from each other via communication circuits which process the same frequency band, whereby the first electronic device 1000 may relay signals between the second electronic device 2000 and the designated network. In this case, by changing a transmission path and a reception path through a switching structure in the first electronic device 1000 and/or the second electronic device 2000, signals may be transmitted between an antenna and a transceiver in the first electronic device 1000 and the second electronic device 2000. For example, as illustrated in FIG. 8 described below, the transmission path and the reception path may be changed through the switching structure in the second electronic device 2000, but the disclosure is not limited thereto.

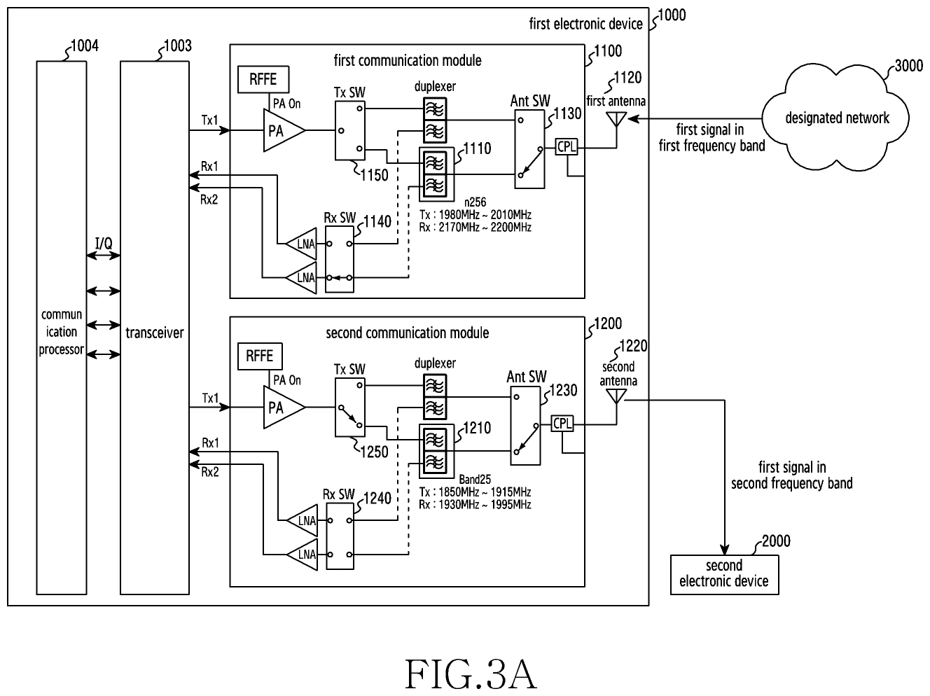

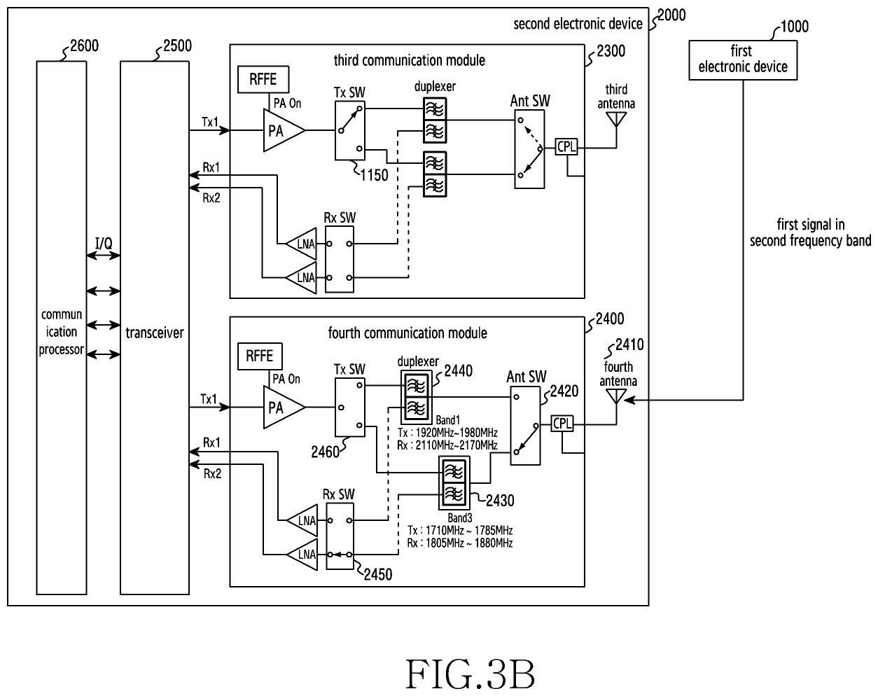

FIG. 3A illustrates an example in which a first electronic device provides a signal from a designated network to a second electronic device, according to an embodiment of the disclosure.

Referring to FIG. 3A, a first electronic device 1000 may switch an antenna switch 1130 and reception switch 1140 in a first communication circuit 1100, so that a first signal in a first frequency band from a designated network 3000 is provided to the transceiver 1003. When the first signal in the first frequency band from the designated network 3000 is received via a first antenna 1120, the antenna switch 1130 of the first communication circuit 1100 may be switched, so that the first signal in the first frequency band is provided via the first duplexer 1110 to the reception switch 1140 of the first communication circuit 1100. In addition, the reception switch 1140 of the first communication circuit 1100 may be switched, so that the first signal in the first frequency band is provided to the transceiver 1003.

Thereafter, for example, the first signal in the first frequency band provided to the transceiver 1003 and/or the communication processor 1004 may be modulated into a first signal in a second frequency band, and the first signal in the second frequency band may be provided to a transmission switch 1250 of a second communication circuit 1200.

In addition, the transmission switch 1250 of the second communication circuit 1200 and an antenna switch 1230 of the second communication circuit 1200 may be switched, so that the first signal in the second frequency band is provided to a second antenna 1220 via the transmission switch 1250 of the second communication circuit 1200, a second duplexer 1210, and the antenna switch 1230 of the second communication circuit 1200. The first signal in the second frequency band may be transmitted to a second electronic device 2000 via the second antenna 1220.

FIG. 3B illustrates an example in which a second electronic device receives a signal from a designated network relayed by a first electronic device, according to an embodiment of the disclosure.

Referring to FIG. 3B, a second electronic device 2000 may switch an antenna switch 2420 and reception switch 2450 in a fourth communication circuit 2400, so that a first signal in a second frequency band from a first electronic device 1000 is provided to a transceiver 2500. When the first signal in the second frequency band is received via a fourth antenna 2410, the antenna switch 2420 of the fourth communication circuit 2400 may be switched, so that the first signal in the second frequency band is provided via a third duplexer 2430 to the reception switch 2450 of the fourth communication circuit 2400. In addition, the reception switch 2450 of the fourth communication circuit 2400 may be switched, so that the first signal in the second frequency band is provided to the transceiver 2500. Since a third frequency band of the third duplexer 2430 partially overlaps with the second frequency band, the first signal in the second frequency band may be provided to the transceiver 2500 via the third duplexer 2430.

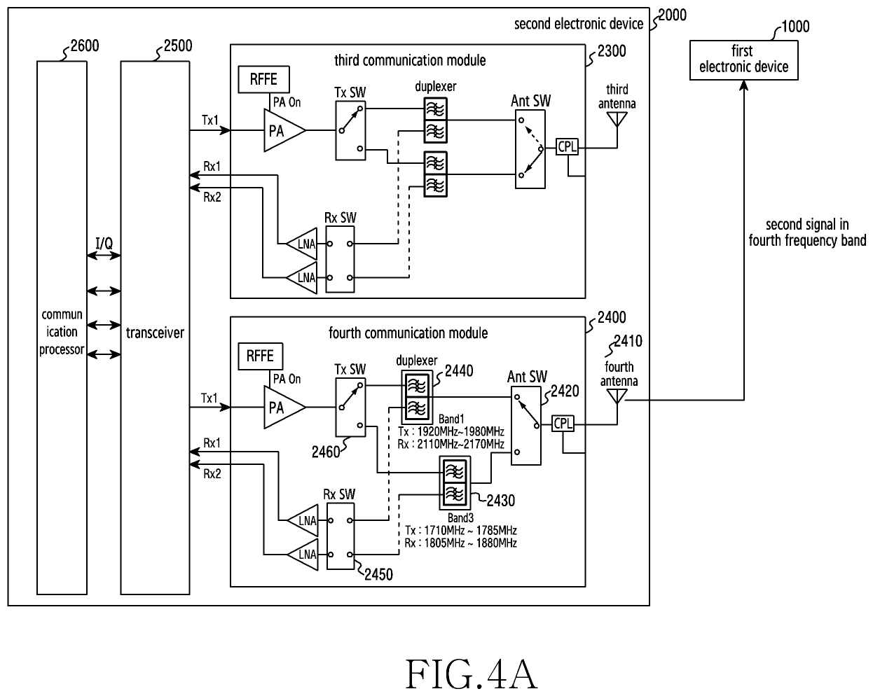

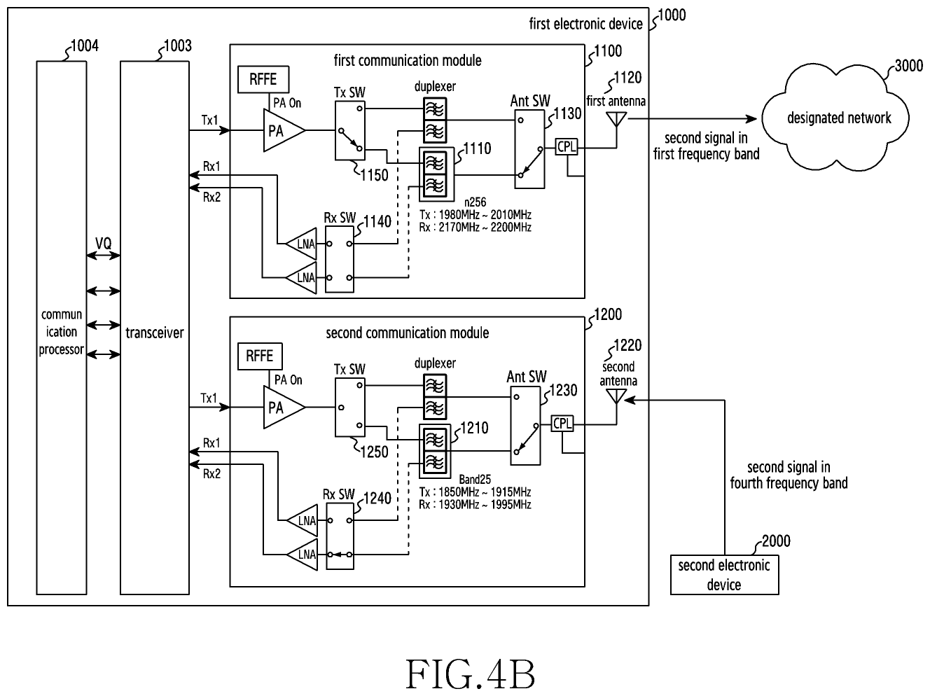

FIG. 4A illustrates an example in which a second electronic device transmits a signal to be provided to a designated network by a first electronic device, according to an embodiment of the disclosure.

Referring to FIG. 4A, a transmission switch 2460 and antenna switch 2420 in a fourth communication circuit 2400 of a second electronic device 2000 may be switched, so that a second signal in a fourth frequency band is provided from a transceiver 2500 to a fourth antenna 2410.

The second electronic device 2000 may generate the second signal in the fourth frequency band for communication via a designated network 3000, and the second signal in the fourth frequency band may be provided from the transceiver 2500 to the transmission switch 2460 of the fourth communication circuit 2400.

In addition, the transmission switch 2460 and antenna switch 2420 of the fourth communication circuit 2400 may be switched, so that the second signal in the fourth frequency band is provided to the fourth antenna 2410 via the transmission switch 2460 of the fourth communication circuit 2400, a fourth duplexer 2440, and the antenna switch 2420 of the fourth communication circuit 2400. The second signal in the fourth frequency band may be transmitted to a first electronic device 1000 via the fourth antenna 2410.

FIG. 4B illustrates an example in which a first electronic device provides a signal from a second electronic device to a designated network, according to an embodiment of the disclosure.

Referring to FIG. 4B, a reception switch 1240 and antenna switch 1230 in a second communication circuit 1200 of a first electronic device 1000 may be switched, so that a second signal in a fourth frequency band is provided from a second antenna 1220 to a transceiver 1003.

The antenna switch 1230 of the second communication circuit 1200 may be switched, so that the second signal in the fourth frequency band received via the second antenna 1220 is provided to a second duplexer 1210. In addition, the reception switch 1240 in the second communication circuit 1200 may be switched, so that the second signal in the fourth frequency band is provided from the second duplexer 1210 to the transceiver 1003. Since the second frequency band of the second duplexer 1210 partially overlaps with the fourth frequency band, the second signal in the fourth frequency band may be provided to the transceiver 1003 via the second duplexer 1210.

Thereafter, the second signal in the fourth frequency band provided to the transceiver 1003 may be modulated into a second signal in a first frequency band, and the second signal in the first frequency band may be provided to a transmission switch 1150 of a first communication circuit 1100.

In addition, the transmission switch 1150 of the first communication circuit 1100 and the antenna switch 1130 of the first communication circuit 1100 may be switched, so that the second signal in the first frequency band is provided to the first antenna 1120 via the transmission switch 1150 of the first communication circuit 1100, a first duplexer 1110, and the antenna switch 1130 of the first communication circuit 1100. The second signal in the first frequency band may be transmitted from the first antenna 1120 to a designated network 3000.

FIG. 5 illustrates an example in which a second frequency band and a third frequency band overlap, according to an embodiment of the disclosure.

Referring to FIG. 5, for example, the second frequency band may be Band 25, and the third frequency band may be Band 3. When the second frequency band is Band 25, a transmission frequency band in the second frequency band may be 1850 MHz to 1915 MHz, and a reception frequency band in the second frequency band may be 1930 MHz to 1995 MHz. When the third frequency band is Band 3, a transmission frequency band in the third frequency band may be 1710 MHz to 1785 MHz, and a reception frequency band in the third frequency band may be 1805 MHz to 1880 MHz.

Referring to FIG. 5, a first signal in the second frequency band transmitted from a first electronic device 1000 to a second electronic device 2000 may be a first signal of the transmission frequency band in the second frequency band. In addition, a transmission frequency band 50 in the second frequency band may partially overlap with a reception frequency band 52 in the third frequency band of a third duplexer 2430.

For example, the transmission frequency band 50 in the second frequency band may be 1850 MHz to 1915 MHz, and the reception frequency band 52 in the third frequency band may be 1805 MHz to 1880 MHz, with a frequency region 54 of 1850 MHz to 1880 MHz overlapping with each other.

In an embodiment, a range of the overlapping frequency region 54 is 30 MHz. Since the range of the overlapping frequency region 54 is greater than a maximum bandwidth of 20 MHz in a first frequency band (e.g., n256), a first signal from a designated network may be transmitted as a signal in the second frequency band and received by the third duplexer 2430.

In FIG. 5, the transmission frequency band in the second frequency band and the reception frequency band in the third frequency band are described as being overlapped, but the disclosure is not limited thereto. For example, the transmission frequency band in the second frequency band may overlap with the transmission frequency band in the third frequency band. Alternatively, for example, the reception frequency band in the second frequency band may overlap with the transmission frequency band in the third frequency band. Alternatively, for example, the transmission frequency band in the second frequency band may overlap with the transmission frequency band in the third frequency band. In addition, the first electronic device 1000 may transmit a first signal in the overlapping frequency band to the second electronic device 2000.

FIG. 6 illustrates an example in which a fourth frequency band and a second frequency band overlap, according to an embodiment of the disclosure.

Referring to FIG. 6, for example, the second frequency band may be Band 25, and the fourth frequency band may be Band 1. When the second frequency band is Band 25, a transmission frequency band in the second frequency band may be 1850 MHz to 1915 MHz, and a reception frequency band in the second frequency band may be 1930 MHz to 1995 MHz. When the fourth frequency band is Band 1, a transmission frequency band in the fourth frequency band may be 1920 MHz to 1980 MHz, and a reception frequency band in the fourth frequency band may be 2110 MHz to 2170 MHz.

Referring to FIG. 6, a second signal in the fourth frequency band transmitted from a second electronic device 2000 to a first electronic device 1000 may be a second signal of the transmission frequency band in the fourth frequency band. In addition, a transmission frequency band 60 in the fourth frequency band may partially overlap with a reception frequency band 62 in the second frequency band of a second duplexer 1210.

For example, the transmission frequency band 60 in the fourth frequency band may be 1920 MHz to 1980 MHz, and the reception frequency band 62 in the second frequency band may be 1930 MHz to 1995 MHz, with a frequency region 64 of 1930 MHz to 1980 MHz overlapping with each other. In an embodiment, a range of the overlapping frequency region 64 is 50 MHz. The range of the overlapping frequency band 64 may be greater than the maximum bandwidth of 20 MHz in a first frequency band (e.g., n256).

In FIG. 6, the transmission frequency band in the fourth frequency band and the reception frequency band in the second frequency band are described as being overlapped, but the disclosure is not limited thereto. For example, the transmission frequency band in the fourth frequency band may overlap with the transmission frequency band in the second frequency band. Alternatively, for example, the reception frequency band in the fourth frequency band may overlap with the transmission frequency band in the second frequency band. Alternatively, for example, the reception frequency band in the fourth frequency band may overlap with the transmission frequency band in the second frequency band. In addition, the second electronic device 2000 may transmit a second signal in the overlapping frequency band to the first electronic device 1000.

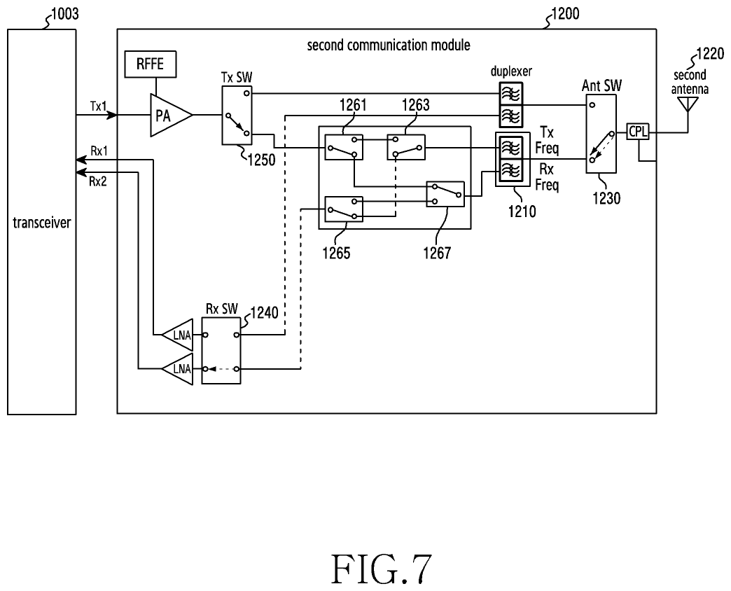

FIG. 7 illustrates an example in which a switching module is provided in a second communication circuit of a first electronic device, according to an embodiment of the disclosure.

Referring to FIG. 7, a second communication circuit 1200 may include one or more switching modules 1261, 1263, 1265, and 1267 for switching signals transmitted and received between a transmission switch 1250, a reception switch 1240, and a second duplexer 1210. For example, the one or more switching modules 1261, 1263, 1265, and 1267 may include a first switching module 1261, a second switching module 1263, a third switching module 1265, and a fourth switching module 1267.

According to an embodiment, when a first electronic device 1000 intends to transmit a first signal in a second frequency band to a second electronic device 2000 via a second antenna 1220, the first signal in the second frequency band from a transceiver 1003 may be delivered to the second duplexer 1210 via the transmission switch 1250, the first switching module 1261, and the fourth switching module 1267. For example, the first signal in the second frequency band may be delivered to a reception path of the second duplexer 1210 via the transmission switch 1250, the first switching module 1261, and the fourth switching module 1267. However, the disclosure is not limited thereto. For example, unlike shown in FIG. 7, an electrical path may be formed within the second communication circuit 1200 such that the first signal in the second frequency band is delivered to a transmission path of the second duplexer 1210 via the transmission switch 1250, the first switching module 1261, and the second switching module 1263.

According to an embodiment, when the first electronic device 1000 receives a second signal in a fourth frequency band via the second antenna 1220, the second signal in the fourth frequency band delivered from the second antenna 1220 to the second duplexer 1210 may be provided from the second duplexer 1210 to the transceiver 1003 via the second switching module 1263, the third switching module 1265, and the reception switch 1240. For example, the second signal in the fourth frequency band may be delivered from a transmission path of the second duplexer 1210 to the transceiver 1003 via the second switching module 1263, the third switching module 1265, and the reception switch 1240. However, the disclosure is not limited thereto. For example, an electrical path may be formed within the second communication circuit 1200 such that the second signal in the fourth frequency band is delivered from a reception path of the second duplexer 1210 to the transceiver 1003 via the fourth switching module 1267, the third switching module 1265, and the reception switch 1240.

FIG. 8 illustrates an example in which a switching module is included in a fourth communication circuit of a second electronic device, according to an embodiment of the disclosure.

Referring to FIG. 8, a fourth communication circuit 2400 may include one or more switching modules 2471, 2473, 2475, and 2477 for switching signals transmitted and received between a transmission switch 2460, a reception switch 2450, and a third duplexer 2430. For example, the one or more switching modules 2471, 2473, 2475, and 2477 may include a fifth switching module 2471, a sixth switching module 2473, a seventh switching module 2475, and an eighth switching module 2477.

In an embodiment, when a second electronic device 2000 receives a first signal in a second frequency band via a fourth antenna 2410, the first signal in the second frequency band transmitted from the fourth antenna 2410 to the third duplexer 2430 may be provided from the third duplexer 2430 to a transceiver 2500 via the eighth switching module 2477, the seventh switching module 2475, and the reception switch 2450. For example, the first signal in the second frequency band may be provided from a reception path of the third duplexer 2430 to the transceiver 2500 via the eighth switching module 2477, the seventh switching module 2475, and the reception switch 2450. However, the disclosure is not limited thereto. For example, an electrical path may be formed within the fourth communication circuit 2400 such that the first signal in the second frequency band is provided from a transmission path of the third duplexer 2430 to the transceiver 2500 via the sixth switching module 2473, the seventh switching module 2475, and the reception switch 2450.

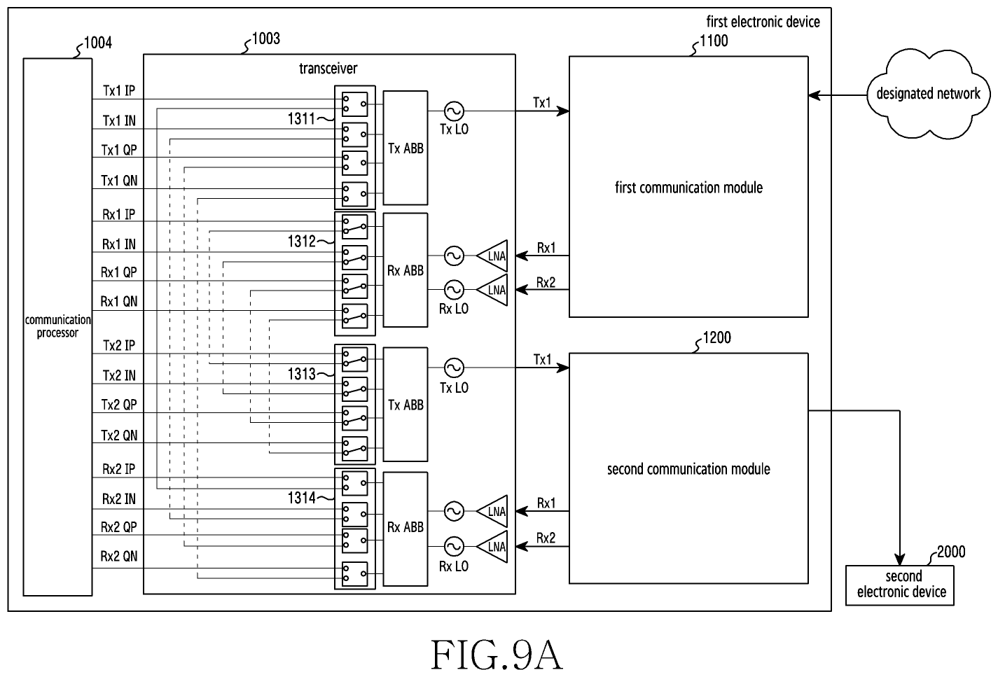

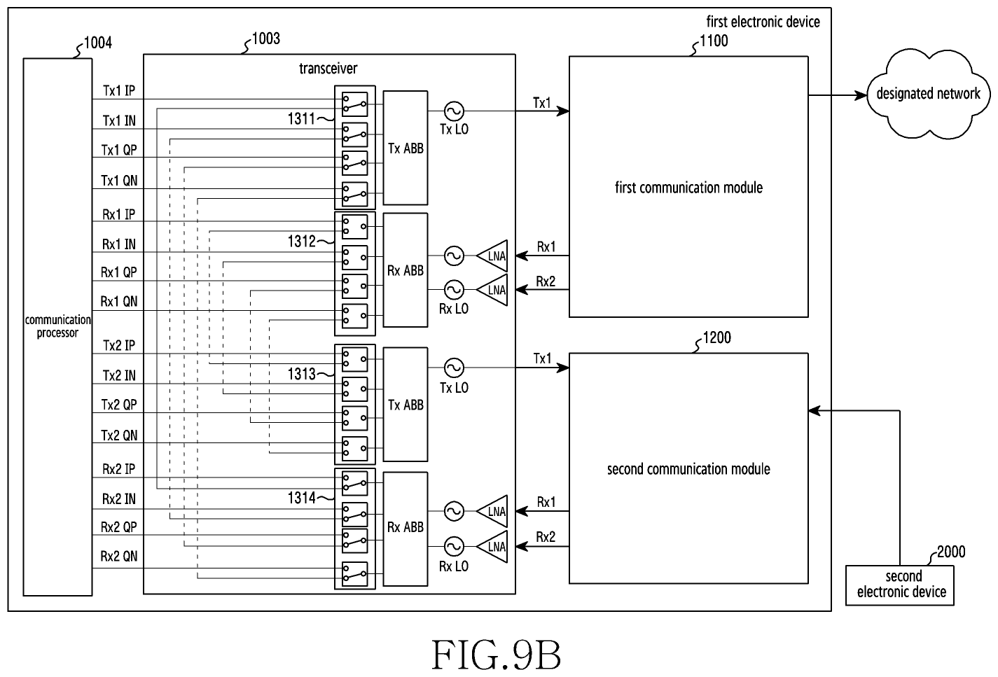

FIG. 9A illustrates an example in which a first signal in a second frequency band, converted from a first signal in a first frequency band, is provided from a first communication circuit to a second communication circuit within a first electronic device through switching, according to an embodiment of the disclosure.

FIG. 9B illustrates an example in which a first signal in a first frequency band, converted from a second signal in a fourth frequency band, is provided from a second communication circuit to a first communication circuit within a first electronic device through switching, according to an embodiment of the disclosure.

Referring to FIGS. 9A and 9B, a transceiver 1003 of a first electronic device 1000 may include a plurality of groups of switches 1311, 1312, 1313, and 1314 for switching signals which may be transmitted and received between a first communication circuit 1100 and a second communication circuit 1200. For example, the plurality of groups of switches 1311, 1312, 1313, and 1314 may include a first group of switches 1311, a second group of switches 1312, a third group of switches 1313, and/or a fourth group of switches 1314.

In an embodiment, the first group of switches 1311 and the second group of switches 1312 may be disposed within the transceiver 1003 to switch signals transmitted to and received from the first communication circuit 1100. For example, the first group of switches 1311 may be disposed within the transceiver 1003 to switch transmission signals to be delivered to the first communication circuit 1100. For example, the second group of switches 1312 may be disposed within the transceiver 1003 to switch reception signals to be received from the first communication circuit 1100.

In an embodiment, the third group of switches 1313 and the fourth group of switches 1314 may be disposed within the transceiver 1003 to switch signals transmitted to and received from the second communication circuit 1200. For example, the third group of switches 1313 may be disposed within the transceiver 1003 to switch transmission signals to be delivered to the second communication circuit 1200. For example, the fourth group of switches 1314 may be disposed within the transceiver 1003 to switch reception signals to be received from the second communication circuit 1200.

Referring to FIG. 9A, according to an embodiment, the second group of switches 1312 and the third group of switches 1313 may be switched, so that a first signal from a designated network is provided from the first communication circuit 1100 to the second communication circuit 1200, without being provided to a communication processor 1004.

Referring to FIG. 9B, in an embodiment, the first group of switches 1311 and the fourth group of switches 1314 may be switched, so that a second signal from a second electronic device 2000 is provided from the second communication circuit 1200 to the first communication circuit 1100, without being provided to the communication processor 1004.

Accordingly, in-phase and quadrature (I/Q) signals may not be unnecessarily delivered to the communication processor 1004, thereby reducing power consumption in the communication processor 1004.

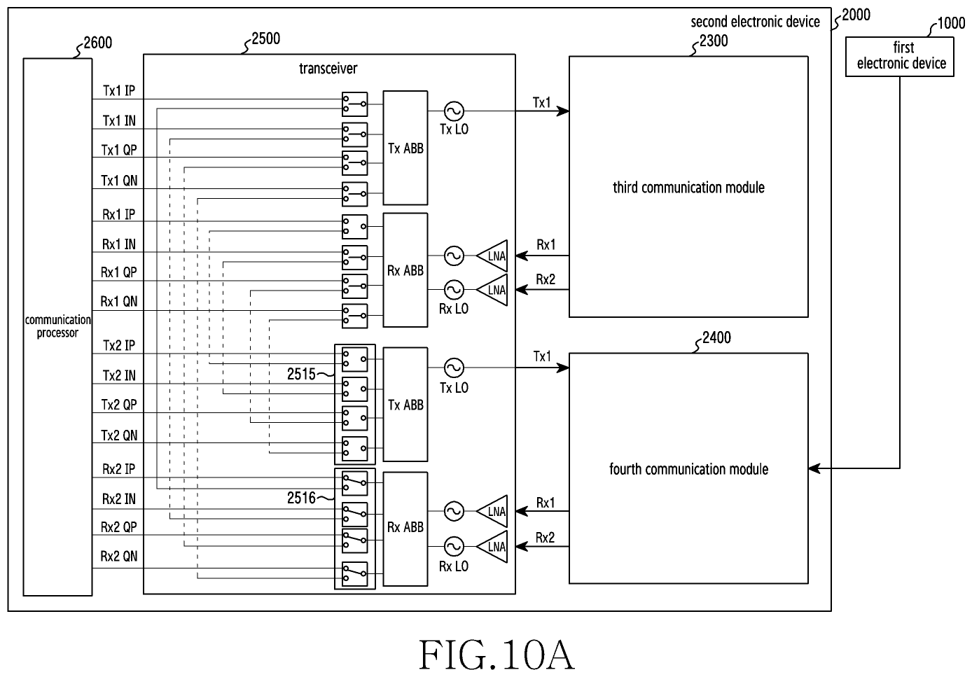

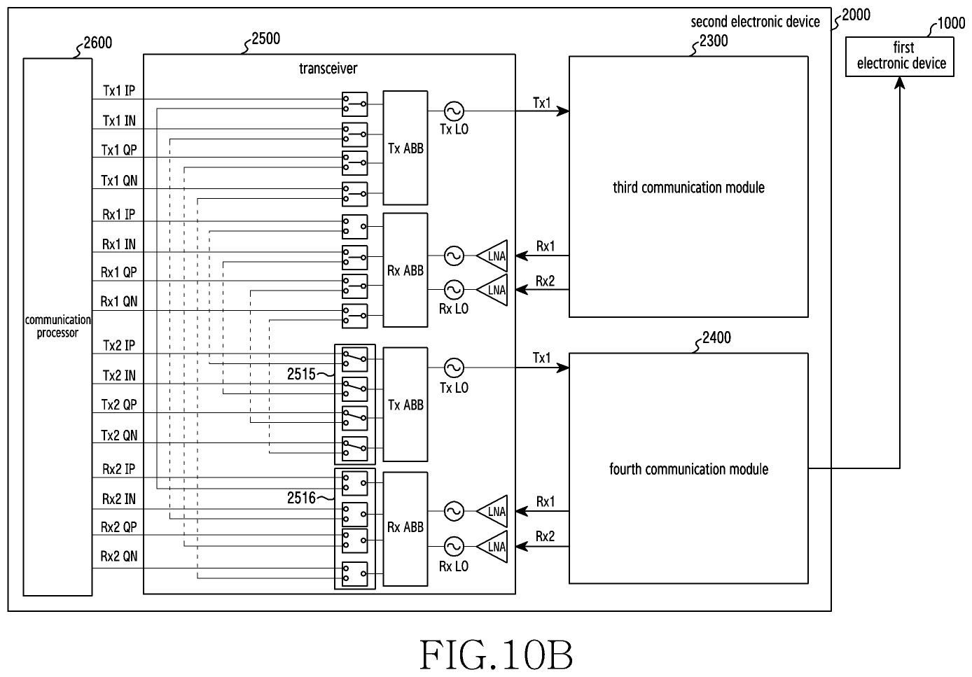

FIG. 10A illustrates an example in which a first signal in a second frequency band is provided from a fourth communication circuit to a communication processor within a first electronic device, according to an embodiment of the disclosure.

FIG. 10B illustrates an example in which a second signal in a fourth frequency band is provided from a communication processor to a fourth communication circuit through switching, according to an embodiment of the disclosure.

Referring to FIGS. 10A and 10B, a transceiver 2500 of a second electronic device 2000 may include a plurality of groups of switches 2515 and 2516 for switching signals which may be transmitted and received between a third communication circuit 2300 and a fourth communication circuit 2400. The plurality of groups of switches 2515 and 2516 may include a fifth group of switches 2515 and a sixth group of switches 2516.

According to an embodiment, the fifth group of switches 2515 may be disposed within the transceiver 2500 to switch transmission signals to be provided to the fourth communication circuit 2400. According to an embodiment, the sixth group of switches 2516 may be disposed within the transceiver 2500 to switch signals received from the fourth communication circuit 2400.

Referring to FIG. 10A, according to an embodiment, the sixth group of switches 2516 may be switched, so that a signal from a first electronic device 1000 is provided to a communication processor 2600 instead of the third communication circuit 2300.

Referring to FIG. 10B, according to an embodiment, the fifth group of switches 2515 may be switched, so that a signal from the communication processor 2600, instead of the third communication circuit 2300, is provided to the fourth communication circuit 2400.

An embodiment of the disclosure may provide a first electronic device (e.g., 1000) for relaying communication with a designated network. The first electro may include: a first communication circuit (e.g., 1100) including a first duplexer (e.g., 1110) for receiving a first signal in a first frequency band from the designated network; a transceiver (e.g., 1300) for receiving the first signal in the first frequency band from the first communication circuit and generating a first signal in a second frequency band from the first signal in the first frequency band; and a second communication circuit (e.g., 1200) which includes a second duplexer (e.g., 1210) for receiving, from the transceiver, the first signal in the second frequency band, and transmits the first signal in the second frequency band to a second electronic device. The first signal in the second frequency band may be provided to a third duplexer (e.g., 2430) corresponding to a third frequency band included in the second electronic device. A partial frequency region in the second frequency band may overlap with the third frequency band. The first signal in the second frequency band may be a signal of the partial frequency region which overlaps with the third frequency band.

According to an embodiment of the disclosure, Frequency Division Duplexing (FDD)-type D2D communication may be supported through efficient allocation of resources for filtering frequency bands, thereby expanding coverage of communication (e.g., FDD satellite communication such as n256) for an emergency situation.

In addition, the first duplexer, the second duplexer, and the third duplexer may be for FDD-type communication.

In addition, the first signal in the second frequency band, which is provided to the second electronic device, may be a first signal of a transmission frequency band of the second duplexer corresponding to the second frequency band.

In addition, the third frequency band which overlaps with the partial frequency region in the second frequency band may be a reception frequency band of the third duplexer corresponding to the third frequency band.

In addition, the overlapping partial frequency region may be greater than a maximum bandwidth of the first signal in the first frequency band.

In addition, the second communication circuit may receive a second signal in a fourth frequency band from the second electronic device through the second duplexer. A partial frequency region in the fourth frequency band may overlap with the second frequency band. The second signal in the fourth frequency band may be a signal of the partial frequency region which overlaps with the second frequency band. The transceiver may receive the second signal in the fourth frequency band from the second communication circuit, and generate a second signal in the first frequency band from the second signal in the fourth frequency band. The first communication circuit may transmit the second signal in the first frequency band to the designated network.

In addition, the second signal in the fourth frequency band, which is received from the second electronic device, may be a second signal of a transmission frequency band of a duplexer corresponding to the fourth frequency band within the second electronic device.

In addition, the second frequency band which overlaps with the partial frequency region in the fourth frequency band may be a reception frequency band of the second duplexer corresponding to the second frequency band.

In addition, the second communication circuit may further include: a transmission switch for switching a transmission signal from the transceiver; a reception switch for switching a reception signal to be provided to the transceiver; and a switching module disposed between the transmission switch, the reception switch, and the second duplexer to switch a signal to be delivered between the transmission switch, the reception switch, and the second duplexer.

In addition, the first frequency band may be a frequency band for satellite communication.

In addition, the second frequency band may be Band 25. The third frequency band may be Band 3.

In addition, the fourth frequency band may be Band 1.

An embodiment of the disclosure may provide a second electronic device (e.g., 2000) for requesting transmission of a signal to a designated network. The second electronic device may include: an antenna (e.g., 2410); a transceiver (e.g., 2500) for generating a second signal in a fourth frequency band of which a partial frequency region overlaps with a second frequency band of a first electronic device (e.g., 1000); and a fourth communication circuit (e.g., 2400) which includes a fourth duplexer (e.g., 2440) for receiving the second signal in the fourth frequency band from the transceiver, and transmits the second signal in the fourth frequency band to a first electronic device via the antenna. The second signal in the fourth frequency band may be received by a second communication circuit (e.g., 1200) corresponding to the second frequency band within the first electronic device. The second signal in the fourth frequency band may be converted into a second signal in a first frequency band of the designated network by the first electronic device and may be transmitted from the first electronic device to the designated network.

In addition, the first electronic device and the second electronic device may transmit and receive signals to and from each other through FDD-type communication.

In addition, a partial frequency region of a transmission frequency in the fourth frequency band may overlap with a reception frequency band in the second frequency band.

In addition, the overlapping partial frequency domain may be greater than a maximum bandwidth of the second signal in the first frequency band.

In addition, the first frequency band may be a frequency band for satellite communication.

In addition, the second frequency band may be Band 25. The fourth frequency band may be Band 1.

An embodiment of the disclosure may provide a system for relaying communication with a designated network. The system may include a first electronic device (e.g., 1000) and a second electronic device (e.g., 2000). The first electronic device may include: a first communication circuit (e.g., 1100) including a first duplexer (e.g., 1110) which receives a first signal in a first frequency band from the designated network; a transceiver (e.g., 1300) which receives the first signal in the first frequency band from the first communication circuit and generate a first signal of a second frequency band (e.g., band 25); and a second communication circuit (e.g., 1200) which includes a second duplexer (e.g., 1210) for receiving, from the transceiver, the first signal in the second frequency band, and transmits the first signal in the second frequency band to a second electronic device. The second electronic device may include: a fourth communication circuit (e.g., 2400) including a third duplexer (e.g., 2430) of a third frequency band for receiving the first signal in the second frequency band, the second frequency band (e.g., Band 25) having a partial frequency region overlapping with the third frequency band (e.g., Band 3); and a transceiver (e.g., 2550) for generating a second signal in a fourth frequency band of which a partial frequency region overlaps with the second frequency band of the first electronic device. The fourth communication circuit may include a fourth duplexer (e.g., 2440) for receiving from the transceiver the second signal in the fourth frequency band, and transmits the second signal in the fourth frequency band to the first electronic device.

In addition, the first electronic device and the second electronic device may transmit and receive signals to and from each other through FDD-type communication.

Taking satellites as an example, limited coverage and constraints in throughput or the like make it difficult for the satellites to be used at all times, and there is a limitation in that the satellites are only utilized in emergency situations where the use of cell bands is restricted. Meanwhile, communication available in the emergency situations is likely to be supported through frequency bands such as n256. However, when FDD-type communication is supported, it may be difficult to relay communication between terminals in the existing Device to Device (D2D) manner. Therefore, according to an embodiment of the disclosure, even when available frequency bands for terminals are insufficient, signals may be smoothly relayed between the terminals.

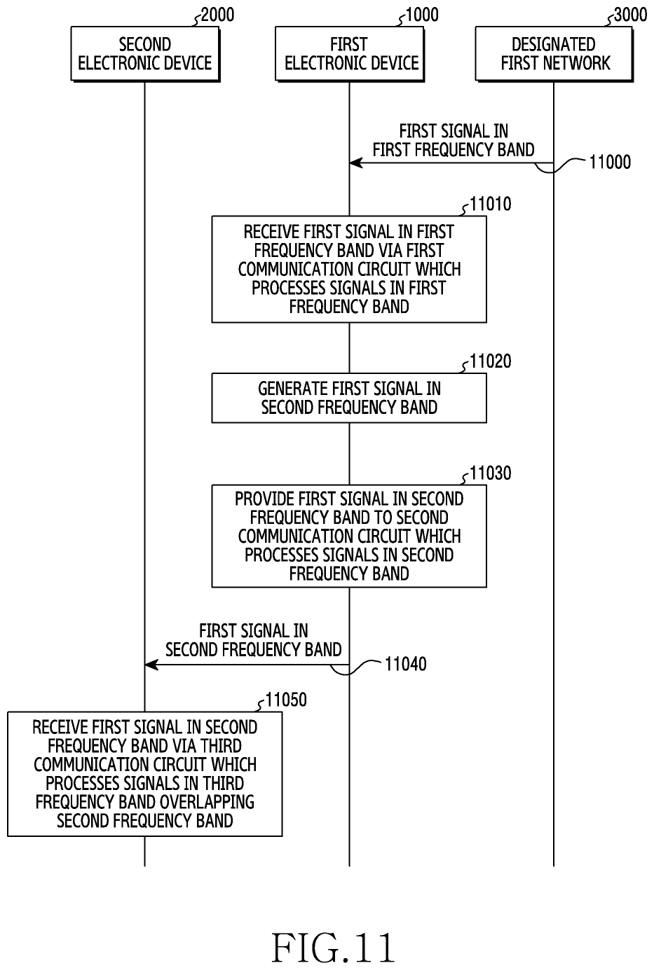

FIG. 11 is a flowchart illustrating a method in which a first electronic device relays a signal from a designated network to a second electronic device, according to an embodiment of the disclosure.

Referring to FIG. 11, in operation 11000, a designated network 3000 may provide a first signal in a first frequency band to a first electronic device 1000. The designated network 3000 may be, for example, a network for satellite communication or a network for transmitting and receiving signals in a disaster situation. The first frequency band may be, for example, an n256 band or an n255 band, but is not limited thereto. When the first frequency band is the n256 band, a transmission frequency band in the first frequency band may be 1980 MHz to 2010 MHz, and a reception frequency band in the first frequency band may be 2170 MHz to 2200 MHz.

In operation 11010, the first electronic device 1000 may receive the first signal in the first frequency band via a first communication circuit 1100 which processes signals in the first frequency band. The first electronic device 1000 may receive the first signal in the first frequency band from the designated network 3000 via a first duplexer 1110 within the first communication circuit 1100.

In operation 11020, the first electronic device 1000 may generate a first signal in a second frequency band. The second frequency band may partially overlap with a third frequency band supported by a second electronic device 2000, and the second frequency band of the first signal to be transmitted from the first electronic device 1000 and the third frequency band of the second electronic device 2000 which receives the first signal may be preset. If the second frequency band and the third frequency band are not preset, the first electronic device 1000 may receive information on frequency bands of signals which are processable by the second electronic device 2000 from the second electronic device 2000, and based on the received information, determine the second frequency band and the third frequency band. For example, the second frequency band may be Band 25, and the third frequency band may be Band 3.

In operation 11030, the first electronic device 1000 may provide the first signal in the second frequency band to a second communication circuit 1200 which processes signals in the second frequency band.

In operation 11040, the first electronic device 1000 may transmit the first signal in the second frequency band to the second electronic device 2000. The first electronic device 1000 may transmit the first signal in the second frequency band, which at least partially overlaps with the third frequency band, to the second electronic device 2000 via a second duplexer 1210.

In operation 11050, the second electronic device 2000 may receive the first signal in the second frequency band via a fourth communication circuit 2400 which processes signals in the third frequency band overlapping with the second frequency band. The second electronic device 2000 may receive the first signal in the second frequency band, which partially overlaps with the third frequency band, from the first electronic device 1000 via a third duplexer 2430 in the third frequency band.

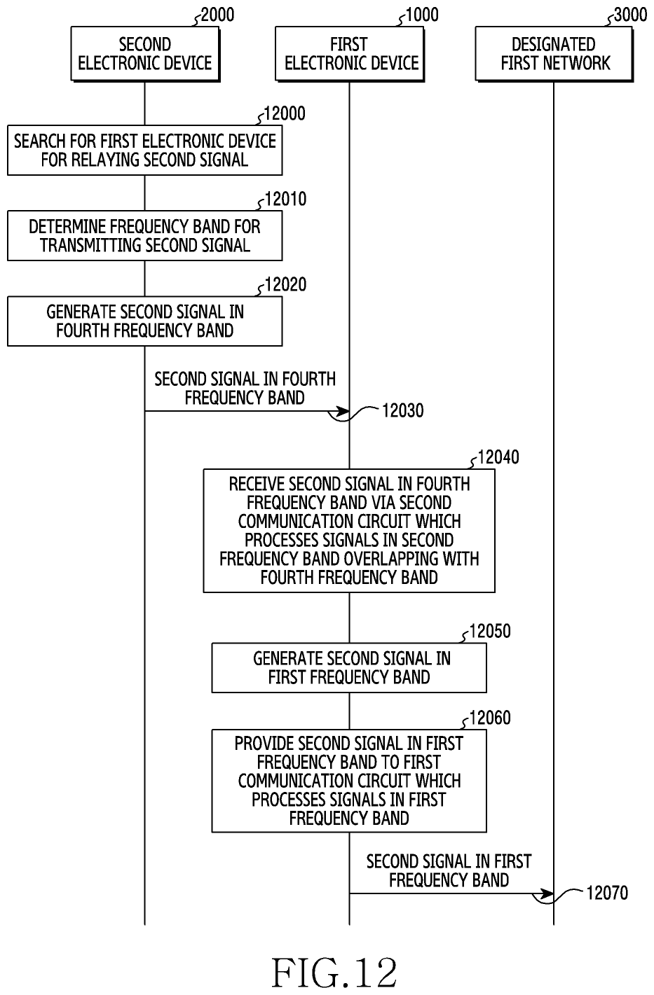

FIG. 12 is a flowchart illustrating a method in which a first electronic device relays a signal from a second electronic device to a designated network, according to an embodiment of the disclosure.

Referring to FIG. 12, in operation 12000, a second electronic device 2000 may search for a first electronic device 1000 for relaying a second signal. When the second electronic device 2000 is unable to transmit the second signal via a designated network 3000, the first electronic device 1000 for relaying the second signal may be searched for.

In operation 12010, the second electronic device 2000 may determine a frequency band for transmitting the second signal. The second electronic device 2000 may receive information on frequency bands supported by the first electronic device 1000 and compare the frequency bands supported by the first electronic device 1000 with frequency bands supported by the second electronic device 2000. According to an embodiment, the second electronic device 2000 may select frequency bands which overlap with each other by a predetermined range or more from among the frequency bands of the first electronic device 1000 and the frequency bands of the second electronic device 2000. In this case, a frequency region in which the selected frequency bands of the first electronic device 1000 and the selected frequency bands of the second electronic device 2000 overlap may be greater than a maximum bandwidth of frequency bands of the designated network 3000.

According to an embodiment, a fourth frequency band of a second signal to be transmitted to the first electronic device 1000 may be preset. In this case, the operation 12010 may be omitted.

In operation 12020, the second electronic device 2000 may generate the second signal in the fourth frequency band. The second electronic device 2000 may generate the second signal to be provided to the designated network 3000 as a signal in the fourth frequency band which partially overlaps with a second frequency band of the first electronic device 1000.

In operation 12030, the second electronic device 2000 may transmit the second signal in the fourth frequency band to the first electronic device 1000. The second electronic device 2000 may transmit the second signal in the fourth frequency band to the first electronic device 1000 via a fourth duplexer 2440 of a fourth communication circuit 2400.

In operation 12040, the first electronic device 1000 may receive the second signal in the fourth frequency band via a second communication circuit which processes signals in the second frequency band overlapping with the fourth frequency band.

In operation 12050, the first electronic device 1000 may generate a second signal in a first frequency band. The first electronic device 1000 may modulate the second signal in the fourth frequency band into the second signal in the first frequency band, so that the second signal in the first frequency band is transmitted to the designated network 3000.

In operation 12060, the first electronic device 1000 may provide the second signal in the first frequency band to a first communication circuit 1100 which processes signals in the first frequency band. In operation 12070, the first electronic device 1000 may transmit the second signal in the first frequency band to the designated network 3000.

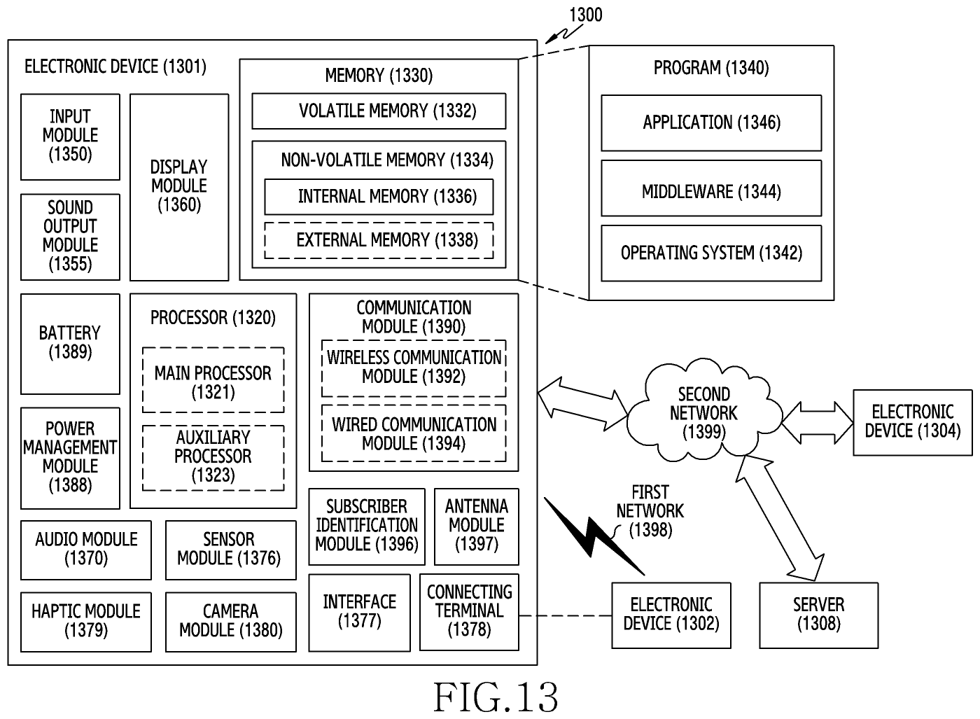

FIG. 13 is a block diagram illustrating an electronic device 1301 in a network environment 1300 according to an embodiment of the disclosure.

Referring to FIG. 13, the electronic device 1301 in the network environment 1300 may communicate with an electronic device 1302 via a first network 1398 (e.g., a short-range wireless communication network), or at least one of an electronic device 1304 or a server 1308 via a second network 1399 (e.g., a long-range wireless communication network). According to an embodiment, the electronic device 1301 may communicate with the electronic device 1304 via the server 1308. According to an embodiment, the electronic device 1301 may include a processor 1320, memory 1330, an input module 1350, a sound output module 1355, a display module 1360, an audio module 1370, a sensor module 1376, an interface 1377, a connecting terminal 1378, a haptic module 1379, a camera module 1380, a power management module 1388, a battery 1389, a communication module 1390, a subscriber identification module (SIM) 1396, or an antenna module 1397. In some embodiments, at least one of the components (e.g., the connecting terminal 1378) may be omitted from the electronic device 1301, or one or more other components may be added in the electronic device 1301. In some embodiments, some of the components (e.g., the sensor module 1376, the camera module 1380, or the antenna module 1397) may be implemented as a single component (e.g., the display module 1360).

The processor 1320 may execute, for example, software (e.g., a program 1340) to control at least one other component (e.g., a hardware or software component) of the electronic device 1301 coupled with the processor 1320, and may perform various data processing or computation. According to one embodiment, as at least part of the data processing or computation, the processor 1320 may store a command or data received from another component (e.g., the sensor module 1376 or the communication module 1390) in volatile memory 1332, process the command or the data stored in the volatile memory 1332, and store resulting data in non-volatile memory 1334. According to an embodiment, the processor 1320 may include a main processor 1321 (e.g., a central processing unit (CPU) or an application processor (AP)), or an auxiliary processor 1323 (e.g., a graphics processing unit (GPU), a neural processing unit (NPU), an image signal processor (ISP), a sensor hub processor, or a communication processor (CP)) that is operable independently from, or in conjunction with, the main processor 1321. For example, when the electronic device 1301 includes the main processor 1321 and the auxiliary processor 1323, the auxiliary processor 1323 may be adapted to consume less power than the main processor 1321, or to be specific to a specified function. The auxiliary processor 1323 may be implemented as separate from, or as part of the main processor 1321.

The auxiliary processor 1323 may control at least some of functions or states related to at least one component (e.g., the display module 1360, the sensor module 1376, or the communication module 1390) among the components of the electronic device 1301, instead of the main processor 1321 while the main processor 1321 is in an inactive (e.g., sleep) state, or together with the main processor 1321 while the main processor 1321 is in an active state (e.g., executing an application). According to an embodiment, the auxiliary processor 1323 (e.g., an image signal processor or a communication processor) may be implemented as part of another component (e.g., the camera module 1380 or the communication module 1390) functionally related to the auxiliary processor 1323. According to an embodiment, the auxiliary processor 1323 (e.g., the neural processing unit) may include a hardware structure specified for artificial intelligence model processing. An artificial intelligence model may be generated by machine learning. Such learning may be performed, e.g., by the electronic device 1301 where the artificial intelligence is performed or via a separate server (e.g., the server 1308). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1330 may store various data used by at least one component (e.g., the processor 1320 or the sensor module 1376) of the electronic device 1301. The various data may include, for example, software (e.g., the program 1340) and input data or output data for a command related thereto. The memory 1330 may include the volatile memory 1332 or the non-volatile memory 1334.

The program 1340 may be stored in the memory 1330 as software, and may include, for example, an operating system (OS) 1342, middleware 1344, or an application 1346.

The input module 1350 may receive a command or data to be used by another component (e.g., the processor 1320) of the electronic device 1301, from the outside (e.g., a user) of the electronic device 1301. The input module 1350 may include, for example, a microphone, a mouse, a keyboard, a key (e.g., a button), or a digital pen (e.g., a stylus pen).

The sound output module 1355 may output sound signals to the outside of the electronic device 1301. The sound output module 1355 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1360 may visually provide information to the outside (e.g., a user) of the electronic device 1301. The display module 1360 may include, for example, a display, a hologram device, or a projector and control circuitry to control a corresponding one of the display, hologram device, and projector. According to an embodiment, the display module 1360 may include a touch sensor adapted to detect a touch, or a pressure sensor adapted to measure the intensity of force incurred by the touch.

The audio module 1370 may convert a sound into an electrical signal and vice versa. According to an embodiment, the audio module 1370 may obtain the sound via the input module 1350, or output the sound via the sound output module 1355 or a headphone of an external electronic device (e.g., an electronic device 1302) directly (e.g., wiredly) or wirelessly coupled with the electronic device 1301.

The sensor module 1376 may detect an operational state (e.g., power or temperature) of the electronic device 1301 or an environmental state (e.g., a state of a user) external to the electronic device 1301, and then generate an electrical signal or data value corresponding to the detected state. According to an embodiment, the sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used for the electronic device 1301 to be coupled with the external electronic device (e.g., the electronic device 1302) directly (e.g., wiredly) or wirelessly. According to an embodiment, the interface 1377 may include, for example, a high definition multimedia interface (HDMI), a universal serial bus (USB) interface, a secure digital (SD) card interface, or an audio interface.

A connecting terminal 1378 may include a connector via which the electronic device 1301 may be physically connected with the external electronic device (e.g., the electronic device 1302). According to an embodiment, the connecting terminal 1378 may include, for example, a HDMI connector, a USB connector, a SD card connector, or an audio connector (e.g., a headphone connector).

The haptic module 1379 may convert an electrical signal into a mechanical stimulus (e.g., a vibration or a movement) or electrical stimulus which may be recognized by a user via his tactile sensation or kinesthetic sensation. According to an embodiment, the haptic module 1379 may include, for example, a motor, a piezoelectric element, or an electric stimulator.

The camera module 1380 may capture a still image or moving images. According to an embodiment, the camera module 1380 may include one or more lenses, image sensors, image signal processors, or flashes.

The power management module 1388 may manage power supplied to the electronic device 1301. According to one embodiment, the power management module 1388 may be implemented as at least part of, for example, a power management integrated circuit (PMIC).

The battery 1389 may supply power to at least one component of the electronic device 1301. According to an embodiment, the battery 1389 may include, for example, a primary cell which is not rechargeable, a secondary cell which is rechargeable, or a fuel cell.

The communication module 1390 may support establishing a direct (e.g., wired) communication channel or a wireless communication channel between the electronic device 1301 and the external electronic device (e.g., the electronic device 1302, the electronic device 1304, or the server 1308) and performing communication via the established communication channel. The communication module 1390 may include one or more communication processors that are operable independently from the processor 1320 (e.g., the application processor (AP)) and supports a direct (e.g., wired) communication or a wireless communication. According to an embodiment, the communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device via the first network 1398 (e.g., a short-range communication network, such as Bluetooth™, wireless-fidelity (Wi-Fi) direct, or infrared data association (IrDA)) or the second network 1399 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1392 may identify and authenticate the electronic device 1301 in a communication network, such as the first network 1398 or the second network 1399, using subscriber information (e.g., international mobile subscriber identity (IMSI)) stored in the subscriber identification module 1396.

The wireless communication module 1392 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1392 may support a high-frequency band (e.g., the millimeter wave (mmWave) band) to achieve, e.g., a high data transmission rate. The wireless communication module 1392 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1392 may support various requirements specified in the electronic device 1301, an external electronic device (e.g., the electronic device 1304), or a network system (e.g., the second network 1399). According to an embodiment, the wireless communication module 1392 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 1397 may transmit or receive a signal or power to or from the outside (e.g., the external electronic device) of the electronic device 1301. According to an embodiment, the antenna module 1397 may include an antenna including a radiating element composed of a conductive material or a conductive pattern formed in or on a substrate (e.g., a printed circuit board (PCB)). According to an embodiment, the antenna module 1397 may include a plurality of antennas (e.g., array antennas). In such a case, at least one antenna appropriate for a communication scheme used in the communication network, such as the first network 1398 or the second network 1399, may be selected, for example, by the communication module 1390 (e.g., the wireless communication module 1392) from the plurality of antennas. The signal or the power may then be transmitted or received between the communication module 1390 and the external electronic device via the selected at least one antenna. According to an embodiment, another component (e.g., a radio frequency integrated circuit (RFIC)) other than the radiating element may be additionally formed as part of the antenna module 1397.

According to various embodiments, the antenna module 1397 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1301 and the external electronic device 1304 via the server 1308 coupled with the second network 1399. Each of the electronic devices 1302 or 1304 may be a device of a same type as, or a different type, from the electronic device 1301. According to an embodiment, all or some of operations to be executed at the electronic device 1301 may be executed at one or more of the external electronic devices 1302, 1304, or the server 1308. For example, if the electronic device 1301 should perform a function or a service automatically, or in response to a request from a user or another device, the electronic device 1301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1301. The electronic device 1301 may provide the outcome, with or without further processing of the outcome, as at least part of a reply to the request. To that end, a cloud computing, distributed computing, mobile edge computing (MEC), or client-server computing technology may be used, for example. The electronic device 1301 may provide ultra low-latency services using, e.g., distributed computing or mobile edge computing. In another embodiment, the external electronic device 1304 may include an internet-of-things (IoT) device. The server 1308 may be an intelligent server using machine learning and/or a neural network. According to an embodiment, the external electronic device 1304 or the server 1308 may be included in the second network 1399. The electronic device 1301 may be applied to intelligent services (e.g., smart home, smart city, smart car, or healthcare) based on 5G communication technology or IoT-related technology.

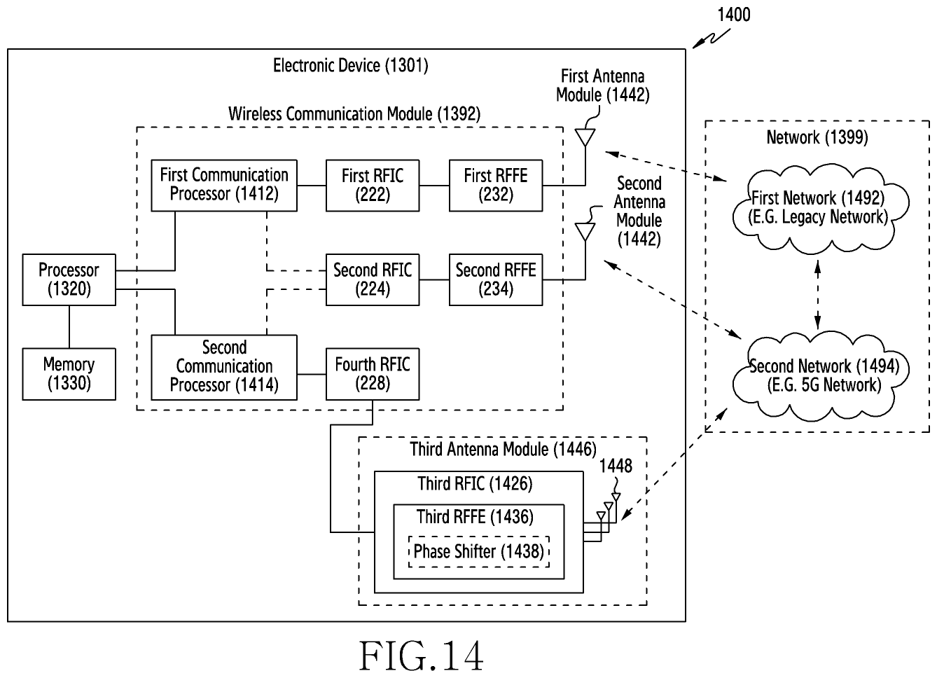

Meanwhile, the electronic device 1301 of FIGS. 13 and 14 may correspond to the first electronic device 1000 and/or second electronic device 2000 of FIGS. 1, 2, 3A, 3B, 4A, 4B, 5 to 8, 9A, 9B, 10A, 10B, 11, and 12. If the electronic device 1301 is the first electronic device 1000, the electronic device 1301 may perform the functions and operations of the first electronic device 1000 described in FIGS. 1, 2, 3A, 3B, 4A, 4B, 5 to 8, 9A, 9B, 10A, 10B, 11, and 12. If the electronic device 1301 is the second electronic device 2000, the electronic device 1301 may perform the functions and operations of the second electronic device 2000 of FIGS. 1, 2, 3A, 3B, 4A, 4B, 5 to 8, 9A, 9B, 10A, 10B, 11, and 12.

FIG. 14 is a block diagram 1400 illustrating an example electronic device 1301 in a network environment including a plurality of cellular networks according to an embodiment of the disclosure.

Referring to FIG. 14, an electronic device 1301 may include a first communication processor (e.g., including processing circuitry) 1412, a second communication processor (e.g., including processing circuitry) 1414, a first radio frequency integrated circuit (RFIC) 1422, a second RFIC 1424, a third RFIC 1426, a fourth RFIC 1428, a first radio frequency front end (RFFE) 1432, a second RFFE 1434, a first antenna module 1442, a second antenna module 1444, and an antenna 1448. The electronic device 1301 may further include a processor (e.g., including processing circuitry) 1320 and memory 1330. The second network 1399 may include a first cellular network 1492 and a second cellular network 1494. According to another embodiment, the electronic device may further include at least one of the parts shown in FIG. 13 and the second network 1399 may further include at least one another network. According to an embodiment, the first communication processor 1412, the second communication processor 1414, the first RFIC 1422, the second RFIC 1424, the fourth RFIC 1428, the first RFFE 1432, and the second RFFE 1434 may form at least a portion of a wireless communication module 1392. According to another embodiment, the fourth RFIC 1428 may be omitted or may be included as a portion of the third RFIC 1426.

The first communication processor 1412 can support establishment of a communication channel with a band to be used for wireless communication with the first cellular network 1492 and legacy network communication through the established communication channel. According to various embodiments, the first cellular network may be a legacy network including a 2G, 3G, 4G, or Long-Term Evolution (LTE) network. The second communication processor 1414 can support establishment of a communication channel corresponding to a designated band (e.g., about 6 GHz˜about 60 GHz) of a band to be used for wireless communication with the second cellular network 1494 and 5G network communication through the established communication channel. According to various embodiments, the second cellular network 1494 may be a 5G network that is defined in 3GPP. Further, according to an embodiment, the first communication processor 1412 or the second communication processor 1414 can support establishment of a communication channel corresponding to another designated band (e.g., about 6 GHz or less) of a band to be used for wireless communication with the second cellular network 1494 and 5G network communication through the established communication channel. According to an embodiment, the first communication processor 1412 and the second communication processor 1414 may be implemented in a single chip or a single package. According to various embodiments, the first communication processor 1412 or the second communication processor 1414 may be disposed in a single chip or a single package together with the processor 1320, the auxiliary processor 1323, or the communication module 1390. According to an embodiment, the first communication processor 1412 and the second communication processor 1414 is directly or indirectly connected by an interface (not shown), thereby being able to provide or receive data or control signal in one direction or two directions.

The first RFIC 1422, in transmission, can converts a baseband signal generated by the first communication processor 1412 into a radio frequency (RF) signal of about 700 MHz to about 3 GHz that is used for the first cellular network 1492 (e.g., a legacy network). In reception, an RF signal can be obtained from the first cellular network 1492 (e.g., a legacy network) through an antenna (e.g., the first antenna module 1442) and can be preprocessed through an RFFE (e.g., the first RFFE 1432). The first RFIC 1422 can covert the preprocessed RF signal into a baseband signal so that the preprocessed RF signal can be processed by the first communication processor 1412.

The second RFIC 1424 can convert a baseband signal generated by the first communication processor 1412 or the second communication processor 1414 into an RF signal in a Sub6 band (e.g., about 6 GHz or less) (hereafter, 5G Sub6 RF signal) that is used for the second cellular network 1494 (e.g., a 5G network). In reception, a 5G Sub6 RF signal can be obtained from the second cellular network 1494 (e.g., a 5G network) through an antenna (e.g., the second antenna module 1444) and can be preprocessed through an RFFE (e.g., the second RFFE 1434). The second RFIC 1424 can convert the processed 5G Sub6 RF signal into a baseband signal so that the processed 5G Sub6 RF signal can be processed by a corresponding communication processor of the first communication processor 1412 or the second communication processor 1414.

The third RFIC 1426 can convert a baseband signal generated by the second communication processor 1414 into an RF signal in a 5G Above6 band (e.g., about 6 GHZ˜about 60 GHZ) (hereafter, 5G Above6 RF signal) that is used for the second cellular network 1494 (e.g., a 5G network). In reception, a 5G Above6 RF signal can be obtained from the second cellular network 1494 (e.g., a 5G network) through an antenna (e.g., the antenna 1448) and can be preprocessed through the third RFFE 1436. The third RFIC 1426 can covert the preprocessed 5G Above6 RF signal into a baseband signal so that the preprocessed 5G Above6 RF signal can be processed by the first communication processor 1412. According to an embodiment, the third RFFE 1436 may be provided as a portion of the third RFIC 1426.

The electronic device 1301, according to an embodiment, may include a fourth RFIC 1428 separately from or as at least a portion of the third RFIC 1426. In this case, the fourth RFIC 1428 can convert a baseband signal generated by the second communication processor 1414 into an RF signal in an intermediate frequency band (e.g., about 9 GHz˜about 11 GHZ) (hereafter, IF signal), and then transmit the IF signal to the third RFIC 1426. The third RFIC 1426 can convert the IF signal into a 5G Above6 RF signal. In reception, a 5G Above6 RF signal can be received from the second cellular network 1494 (e.g., a 5G network) through an antenna (e.g., the antenna 1448) and can be converted into an IF signal by the third RFIC 1426. The fourth RFIC 1428 can covert the IF signal into a baseband signal so that IF signal can be processed by the second communication processor 1414.

According to an embodiment, the first RFIC 1422 and the second RFIC 1424 may be implemented as at least a portion of a single chip or a single package. According to an embodiment, the first RFFE 1432 and the second RFFE 1434 may be implemented as at least a portion of a single chip or a single package. According to an embodiment, at least one of the first antenna module 1442 or the second antenna module 1444 may be omitted, or may be combined with another antenna module and can process RF signals in a plurality of bands.

According to an embodiment, the third RFIC 1426 and the antenna 1448 may be disposed on a substrate, thereby being able to form a third antenna module 1446. For example, the wireless communication module 1392 or the processor 1320 may be disposed on a first substrate (e.g., a main PCB). In this case, the third RFIC 1426 may be disposed in a partial area (e.g., the bottom) and the antenna 1448 may be disposed in another partial area (e.g., the top) of a second substrate (e.g., a sub PCB) that is different from the first substrate, thereby being able to form the third antenna module 1446. By disposing the third RFIC 1426 and the antenna 1448 on the same substrate, it is possible to reduce the length of the transmission line therebetween. Accordingly, it is possible to reduce a loss (e.g., attenuation) of a signal in a high-frequency band (e.g., about 6 GHz˜about 60 GHZ), for example, which is used for 5G network communication, due to a transmission line. Accordingly, the electronic device 1301 can improve the quality and the speed of communication with the second cellular network 1494 (e.g., 5G network).

According to an embodiment, the antenna 1448 may be an antenna array including a plurality of antenna elements that can be used for beamforming. In this case, the third RFIC 1426, for example, as a portion of the third RFFE 1436, may include a plurality of phase shifters 1438 corresponding to the antenna elements. In transmission, the phase shifters 1438 can convert the phase of a 5G Above6 RF signal to be transmitted to the outside of the electronic device 1301 (e.g., to a base station of a 5G network) through the respectively corresponding antenna elements. In reception, the phase shifters 1438 can convert the phase of a 5G Above6 RF signal received from the outside through the respectively corresponding antenna element into the same or substantially the same phase. This enables transmission or reception through beamforming between the electronic device 1301 and the outside.

The second cellular network 1494 (e.g., a 5G network) may be operated independently from (e.g., Stand-Along (SA)) or connected and operated with (e.g., Non-Stand Along (NSA)) the first cellular network 1492 (e.g., a legacy network). For example, there may be only an access network (e.g., a 5G radio access network (RAN) or a next generation RAN (NG RAN)) and there is no core network (e.g., a next generation core (NGC)) in a 5G network. In this case, the electronic device 1301 can access the access network of the 5G network and then can access an external network (e.g., the internet) under control by the core network (e.g., an evolved packed core (EPC)) of the legacy network. Protocol information (e.g., LTE protocol information) for communication with a legacy network or protocol information (e.g., New Radio (NR) protocol information) for communication with a 5G network may be stored in the memory 1430 and accessed by another part (e.g., the processor 1320, the first communication processor 1412, or the second communication processor 1414).

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1340) including one or more instructions that are stored in a storage medium (e.g., internal memory 1336 or external memory 1338) that is readable by a machine (e.g., the electronic device 1301). For example, a processor (e.g., the processor 1320) of the machine (e.g., the electronic device 1301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A first electronic device for relaying communication with a designated network, the first electronic device comprising:
a first communication circuit for receiving a first signal in a first frequency band from the designated network;
a transceiver for receiving the first signal in the first frequency band from the first communication circuit; and
a second communication circuit which includes a second duplexer for receiving, from the transceiver, a first signal in a second frequency band, which is generated from the first signal in the first frequency band, and transmits the first signal in the second frequency band to a second electronic device,
wherein the first signal in the second frequency band is provided to a third duplexer corresponding to a third frequency band included in the second electronic device,
wherein a partial frequency region in the second frequency band overlaps with the third frequency band, and
wherein the first signal in the second frequency band is a signal of the partial frequency region which overlaps with the third frequency band.

2. The first electronic device of claim 1,
wherein the first communication circuit includes a first duplexer for receiving the first signal in the first frequency band, and
wherein the first duplexer, the second duplexer, and the third duplexer are for frequency division duplexing (FDD)-type communication.

3. The first electronic device of claim 1, wherein the first signal in the second frequency band, which is provided to the second electronic device, is a first signal of a transmission frequency band of the second duplexer corresponding to the second frequency band.

4. The first electronic device of claim 3, wherein the third frequency band which overlaps with the partial frequency region in the second frequency band is a reception frequency band of the third duplexer corresponding to the third frequency band.

5. The first electronic device of claim 4, wherein the overlapping partial frequency region is greater than a maximum bandwidth of the first signal in the first frequency band.

6. The first electronic device of claim 1,
wherein the second communication circuit receives a second signal in a fourth frequency band from the second electronic device through the second duplexer,
wherein a partial frequency region in the fourth frequency band overlaps with the second frequency band, and the second signal in the fourth frequency band is a signal of the partial frequency region which overlaps with the second frequency band,
wherein the transceiver receives the second signal in the fourth frequency band from the second communication circuit,
wherein a second signal in the first frequency band is generated from the second signal in the fourth frequency band, and
wherein the first communication circuit transmits the second signal in the first frequency band to the designated network.

7. The first electronic device of claim 6, wherein the second signal in the fourth frequency band, which is received from the second electronic device, is a second signal of a transmission frequency band of a duplexer corresponding to the fourth frequency band within the second electronic device.

8. The first electronic device of claim 7, wherein the second frequency band which overlaps with the partial frequency region in the fourth frequency band is a reception frequency band of the second duplexer corresponding to the second frequency band.

9. The first electronic device of claim 1,
wherein the first frequency band, the second frequency band, and the third frequency band are the same frequency band, and
wherein the second communication circuit further comprises:
a transmission switch for switching a transmission signal from the transceiver,
a reception switch for switching a reception signal to be provided to the transceiver, and
a switching module disposed between the transmission switch, the reception switch, and the second duplexer to switch a signal to be delivered between the transmission switch, the reception switch, and the second duplexer.

10. The first electronic device of claim 1, wherein the first frequency band is a frequency band for satellite communication.

11. The first electronic device of claim 1, wherein the second frequency band is Band 25, and the third frequency band is Band 3.

12. The first electronic device of claim 6, wherein the fourth frequency band is Band 1.

13. A second electronic device for requesting transmission of a signal to a designated network, the second electronic device comprising:
an antenna;
a transceiver; and
a fourth communication circuit which includes a fourth duplexer for receiving a second signal in a fourth frequency band from the transceiver, and transmits the second signal in the fourth frequency band to a first electronic device via the antenna, the second signal in the fourth frequency band having a partial frequency region overlapping with a second frequency band of the first electronic device,
wherein the second signal in the fourth frequency band is received by a second communication circuit corresponding to the second frequency band within the first electronic device, and
wherein the second signal in the fourth frequency band is converted into a second signal in a first frequency band of the designated network by the first electronic device and is transmitted from the first electronic device to the designated network.

14. The second electronic device of claim 13,
wherein a partial frequency region of a transmission frequency in the fourth frequency band overlaps with a reception frequency band in the second frequency band, and
wherein the overlapping partial frequency region is greater than a maximum bandwidth of the second signal in the first frequency band.

15. A system for relaying communication with a designated network, the system comprising:
a first electronic device comprising:
a first communication circuit including a first duplexer which receives a first signal in a first frequency band from the designated network,
a transceiver for receiving the first signal in the first frequency band from the first communication circuit, and
a second communication circuit which includes a second duplexer for receiving, from the transceiver, a first signal in a second frequency band, which is generated from the first signal in the first frequency band, and transmits the first signal in the second frequency band to a second electronic device; and
a second electronic device comprising:
a fourth communication circuit including a third duplexer of a third frequency band for receiving the first signal in the second frequency band, the second frequency band having a partial frequency region overlapping with the third frequency band, and
a transceiver,
wherein the fourth communication circuit includes a fourth duplexer for receiving from the transceiver a second signal in a fourth frequency band of which a partial frequency region overlaps with the second frequency band, and
wherein the fourth communication circuit transmits the second signal in the fourth frequency band to the first electronic device.

16. The system of claim 15, wherein the first duplexer, the second duplexer, and the third duplexer are for frequency division duplexing (FDD)-type communication.

17. The system of claim 15, wherein the first signal in the second frequency band, which is provided to the second electronic device, is a first signal of a transmission frequency band of the second duplexer corresponding to the second frequency band.

18. The system of claim 17, wherein the third frequency band which overlaps with the partial frequency region in the second frequency band is a reception frequency band of the third duplexer corresponding to the third frequency band.

19. The system of claim 18, wherein the overlapping partial frequency region is greater than a maximum bandwidth of the first signal in the first frequency band.

20. The system of claim 15, wherein the first communication circuit transmits the second signal in the first frequency band to the designated network.
